(19) United States
(12) Patent Application Publication
(10) Pub. No.: US 2026/0045177 A1
(43) Pub. Date: Feb. 12, 2026

(54) Speech Therapy System and Method Therefor

(71) Applicant: fluencyAI, LLC, Arlington, MA (US)

(72) Inventor: Steven Douglas Scott, Arlington, MA (US)

(21) Appl. No.: 19/269,204

(22) Filed: Jul. 15, 2025

Related U.S. Application Data
(60) Provisional application No. 63/681,288, filed on Aug. 9, 2024.

(51) Int. Cl. G09B 19/04; G09B 5/06

(52) U.S. Cl. CPC G09B 19/04; G09B 5/065

(57) ABSTRACT

A speech therapy system and method therefor are disclosed. The system includes graduated speaking exercise modules and a computer system including a processor and a memory. The modules are arranged sequentially and are collectively configured to provide graduated speaking exercises, or GSEs, of increasing conversational realism for a stuttering user. The processor executes the app and the modules, and each of the modules create an associated GSE that defines a different state of the app. When the app is in a current state defined by a current GSE, the app obtains or determines a fluency metric from user speech or from a user fluency self-rating. When the metric meets an upper fluency threshold of the current GSE, the app transitions to a next app state defined by a next GSE, and the app can conclude that the user is fluent if the upper threshold is met for a final GSE.

### RELATED APPLICATIONS

This application claims the benefit under 35 USC 119(e) of U.S. Provisional Application No. 63/681,288 filed on Aug. 9, 2024, which is incorporated herein by reference in its entirety.

### FIELD OF THE INVENTION

The invention relates generally to computer-based therapies for improving speech fluency, and more particularly to an artificial intelligence based speech therapy system and method for stuttering users that enables the users to achieve speech fluency.

### BACKGROUND OF THE INVENTION

Stuttering is a serious speech disorder that affects people of all ages and significantly disrupts their normal flow of speech. Stuttering affects approximately 3.0 to 5.0 percent of preschool-aged children and 0.7 to 1.0 percent of the general population worldwide. Stuttering is characterized by speech disruptions including frequent repetitions or prolongations of speech sounds, syllables or words, and interruptions during speech including the inability to begin speaking a word or hesitation when speaking. These speech disruptions may be accompanied by muscle movements including rapid eye blinks, tremors of the lips or jaw or other “struggle behaviors” of the face or upper body that an individual who stutters may exhibit when speaking. A person who stutters (PWS) is also known as a stutterer.

Stutterers often experience a fear or anticipation of disfluencies on particular sounds, words, or word combinations, especially for sounds or words which they have stuttered when speaking on previous occasions. These sounds, words, or word combinations upon which a PWS experiences stuttering when reciting aloud are also known as problem words. Consequently, stutterers sometimes ‘scan ahead’ their upcoming conversational speech for problem words in an effort to identify acceptable synonyms that they can pronounce fluently. Some stutterers are sufficiently practiced at word-avoidance so that their stuttering is not noticeable to casual listeners. At the same time, there remains a strong psychological strain on the stutterer, including the fear of not finding an acceptable substitute word in time. As a result, stutterers often limit or avoid problematic conversational situations such as talking on the telephone. In severe cases, stutterers may avoid conversation generally, leading to acute social isolation.

While stuttering is a poorly understood affliction, researchers generally believe that it is at least in part a learned disability. During childhood, most people experience some periods of speaking disfluency, such as the inability to formulate spoken words without repetition of particular sounds. For most children, this phase passes without incident and has no effect on their subsequent speaking skills. However, in about 1 percent of the population, the speaker becomes cognizant of the problem and strains the vocal cords in an attempt to generate fluent speech. The thesis is that the stutterer's fear or anticipation of stuttering leads to the stuttering itself. See O. Bloodstein and N. Bernstein Ratner, “A Handbook on Stuttering (Sixth Ed.),” Delmar, Cengage Learning, Clifton Park, NY (2008), p. 43. This is termed the Anticipatory Struggle Hypothesis (ASH) and has been the subject of considerable stuttering research since the 1930s. A seventh edition of this handbook is considered to be the standard of stuttering research. See O. Bloodstein, N. Bernstein Ratner, and S. Brundage “A Handbook on Stuttering (Seventh Ed.)”, Plural Publishing, San Diego (2021), hereinafter the Bloodstein Handbook.

In more detail, “[t]he anticipatory struggle hypothesis holds, in brief, that a person stutters because he believes in the difficulty of speech, anticipates failure, and struggles to avoid it. His very efforts to avoid difficulty are his stutterings, or lead directly to them. Having stuttered, he is vindicated in his expectation of speech difficulty, and so the cycle continues.” See Bloodstein, O., “The anticipatory struggle hypothesis—implications of research on the variability of stuttering. ”J Speech Hear Res. 1972 Sep;15(3):487-99.

The ASH is associated with a broad array of observed stuttering phenomena, including that stutterers can accurately predict certain words that are problematic for them. At the same time, there is often no corresponding sound specificity, i.e., stutterers might fear a word beginning with the letter ‘f’ but not ‘ph’. The ASH is consistent with the critical observation that stutterers'fluency often improves, sometimes dramatically, when speaking alone. A recent 2021 study found that a set of 24 stutterers experienced near-perfect fluency when they were convinced that they were truly alone, that their speech was not intended to be heard by other people, and that their speech was not being recorded. See. E. S. Jackson, L. R. Miller, H. J. Warner, and J. S. Yaruss, “Adults who stutter do not stutter during private speech”, J. Fluency Disorders 70 (2021) 105878, (hereinafter “Jackson 2021”). In contrast, stutterers'fluency often decreases in situations where the social consequences of stuttering are greater, such as when speaking before a group. To wit, according to Jackson 2021, “. . . speakers'perceptions of listeners, whether real or imagined, play a critical and likely necessary role in the manifestation of stuttering events.”Id.

Therapists typically employ different speech therapies to treat stuttering and have developed programs that use these therapies. These existing programs generally require that the user attend an in-person clinic or outpatient setting, and attempt to ‘teach’ the stutterer how to improve his or her fluency through breathing and/or voicing techniques. The assumption that underlies these existing programs is that there is something innately wrong with stutterers'production of speech that needs to be fixed or altered and can be changed through extensive coaching and training. The existing programs include diaphragmatic breathing and muscle relaxation during speech, and voicing techniques such as “stretched syllables” that prolong pronunciation of words, in examples.

One of the most well-known stuttering therapy programs is the Hollins precision fluency shaping program (Hollins program). See Ronald L. Webster, From Stuttering to Fluent Speech, 6,300 Cases Later: Unlocking Muscle Mischief, CreateSpace Independent Publishing Platform, North Charleston, South Carolina (2014). The Hollins program was administered by the Hollins Communications Research Institute (HCRI) in Roanoke, Virginia, in a 12-day onsite residential program. The HCRI website, www.stuttering.org, claimed that 93% of individuals in the program achieved fluency in 12 days and that 75% of the individuals retained fluency when evaluated two years later. The Hollins program has spawned a number of similar stuttering therapy programs (Kassel; D.E.L.P.H.I.N.; De Nil and Kroll; Franken, Boves, Peters and Webster; and the Walter Reed stuttering treatment programs). However, the Hollins program itself stopped accepting patients for onsite therapy in June of 2023.

Many other speech therapy programs for stuttering have been proposed, implemented, and evaluated over the past eighty years. Chapter 14 of the Bloodstein Handbook describes more than two dozen stuttering therapies or programs. While many of these programs initially improve fluency, recidivism a year following the end of treatment is often significant.

Additionally, hardware-based speech therapy systems have been proposed. These existing systems focus on auditory processing of the user's own speech to treat stuttering, and include various eletromechanical devices to decrease the user's stuttering. Exemplary systems include delayed auditory feedback systems (DAF systems), frequency-altered auditory feedback systems (FAF systems), and masking speech systems, in examples. These systems include a microphone and headphones/earphones connected to computer, and present the user's spoken voice to their ears with a delay, from as much as 200 milliseconds (ms) to as little as 30 ms. The FAF systems additionally employ computer algorithms that change the pitch at which the users hear their own voices. The masker systems typically generate “white noise”that is communicated to its users through headphones or earpods.

A typical example of hardware-based stuttering assisting devices is SpeechEasy earpods. SpeechEasy is a registered trademark of the Janus Development Group, Inc. These earpods typically cost anywhere from $2,500-$4,500 USD and deliver the users'DAF and/or FAF-modified speech to the users'ears.

Virtual Reality (VR) technology has also been used to decrease stuttering. The VR technology includes a headset that displays a virtual audience to the users. In early implementations, VR technology was directed to helping stuttering users overcome fear of speaking in public. Over time, the VR technology additionally attempted to improve the fluency of stutterers.

### SUMMARY OF THE INVENTION

The existing speech therapy programs for treating stuttering have problems. The existing breathing and vocalizing programs are typically performed one-on-one with a therapist in a clinical setting, which adds cost. Moreover, the successful speech therapy programs described hereinabove may require extended residential stays of days or weeks under controlled conditions, may require monitoring over time after the treatment, and are expensive.

The existing speech therapy hardware systems also have problems. The existing systems are typically expensive, time-consuming, and although individual systems claim good success rates, they are not widely utilized by the stuttering population.

A proposed speech therapy system is disclosed. The proposed system is designed to overcome the problems and limitations of the existing speech therapy programs and the existing hardware speech therapy systems. The proposed system is based on at least three assumptions: (1) the ASH thesis is basically correct, i.e., it is the stutterer's expectation of stuttering that leads to the disfluency itself; (2) if an expectation of stuttering can be learned, it can also be unlearned by immersing the stutterer in an extended series of monologues and conversations of increasing conversational realism in which he or she experiences fluent speech; and (3) there exists a starting point at which many if not most stutterers are indeed fluent, i.e., are fluent “when speaking alone.”

Jackson coined the term ‘private speech’ to characterize a speaking environment in which speakers intend their speech to be for their own purpose only (such as muttering under one's breath), in which the speakers completely believe that their speech cannot be heard by other persons, and in which their speech is not recorded. The proposed speech therapy system makes a subtle distinction between conversational environments which meet Jackson's definition of private speech, versus ‘speaking while alone’ environments. Specifically, the proposed system leverages the advantages of the ‘speaking while alone’ environments, in which speakers who stutter fully believe that other people cannot hear their speech; at the same time, various software components of the proposed system are configured to ‘listen to’, and process, their speech.

In one example, components of the proposed speech therapy system may transcribe user speech into text, or apply various algorithms to the speech to compute a fluency metric. In another example, the components of the proposed system might include or otherwise use software modules with artificial intelligence capabilities to “sanitize” words spoken by the user into text-based versions of the spoken words that remove many, if not most, of stuttered words spoken by the user. In another example, the components of the proposed system may be configured to interpret an intended meaning of user speech and to develop appropriate text-based or audio responses using artificial intelligence software modules.

The proposed speech therapy system includes a fluency management application (“app”) that executes upon a computer system, and includes a sequence of modules that create or otherwise provide speaking exercises of increasing conversational realism. Each module includes or otherwise provides at least one speaking exercise (namely, a graduated speaking exercise, or GSE), and thus the modules themselves are also known as GSE modules. Each GSE module includes instructions and rules that configure operation of the system and its components. The app executes each GSE module, the execution of which creates at least one GSE for each GSE module that also defines a state of the app.

The proposed speech therapy system also communicates with one or more remote computer systems over a network, such as the Internet. Via GSE modules/GSEs of increased conversational realism, the app can configure the (local) computer system to enable the user to communicate with artificial conversational entities or with one or more humans at the remote computer systems. Human conversational partners located at the remote computer systems are also known as Remote Conversational Partners (RCPs). For this purpose, in one example, the GSE created by a GSE module might configure a user video conference application at the computer system for communication with one or more peer remote video conference applications at each of the remote computer systems. Examples of the video conference applications include Google Meet, Zoom, and/or Microsoft Teams.

During operation of the proposed speech therapy system, the user is required to achieve fluency at the level of each GSE/app state, before being “promoted” to a next GSE/app state of increasing conversational realism or stress. An initial GSE/app state provides a “private speech” speech environment, during which the system maintains at least the level of fluency that stutterers have innately when alone. Each subsequent GSE/app state then increasingly expands the range of conversational situations in which the user must remain fluent. The final GSEs/app states place the stuttering user in speech environments in which the user's speech is heard in real time by other humans. The app state defined by each GSE is also known as a “step” or state of the system.

The system provides a speech therapy program for stuttering users. When a user completes the program, the system concludes that the user is fluent and notifies the user in response. As the system promotes the user to each successive step of the program, the user is presented with an expanded range of conversational situations of incrementally-increasing conversational realism in which the user is expected to remain fluent. Toward the end of the program, the GSEs that define the steps of the program are configured to create conversational sessions/situations that expose the users to, and require the users to engage in, conversations with the highest levels of conversational realism and stress that the system provides. These conversational situations may include extemporaneous, real-time conversations with multiple conversation partners including full audio and video signals, in examples. The conversational partners may be human and/or artificial in nature. In one example, an artificial conversation entity such as a chatGPT software module can create and engage in conversation, in text and/or audio form, with the user. Here, chatGPT is the name of a “chatbot” artificial conversation entity product sold by OpenAI, Inc.

The proposed speech therapy system also maintains a list of problem words for each user and enables each user to enter or delete problem words from the list. For this purpose, during one or more GSEs, the system can provide an interface, such as a graphical user interface (GUI), that enables the users to enter or remove problem words from the list. The system then saves the list to a data repository of the system. For each user, the system can access the list of problem words at system startup, update the list during one or more GSEs at system runtime, and then access the updated list of problem words thereafter. In one example, the one or more GSEs can present text passages at the GUI for the user to recite, and the user can identify additional problem words in the text passages. The system then updates the list of problem words to include the additional problem words. When the system presents new text passages for the user to recite thereafter, the system typically first searches the list of problem words, and excludes the problem words in the list from the new text passages.

The proposed speech therapy system has other advantages over the existing speech therapy programs and the existing hardware speech therapy systems. In one example, neither the existing programs nor the existing systems can provide their therapies remotely and economically through communications networks such as the Internet, as the proposed system can. The proposed system is controlled by the user and is accessible via a computer system, without the need to attend a residential program or therapist's office, which eliminates transportation logistics and saves time and cost. The proposed system also does not require specialized biofeedback computer systems, as in the existing hardware-based speech therapy systems.

Moreover, the existing systems are costly and include specialized hardware and software (especially the FAF systems) and have a mixed track record of success in improving long-term fluency. In contrast, the proposed speech therapy system allows the user to achieve fluency in a controlled and repeatable manner, using standard “off the shelf” computer systems such as a Microsoft Windows-based or Apple IOS-based personal computer.

Windows and IOS are registered trademarks of Microsoft Corporation and Apple, Inc, respectively.

Additionally, while the existing programs and systems teach the users various techniques to change their speaking, pronunciation, or breathing style, the proposed speech therapy system imposes no such requirement upon stutterers. In contrast, the proposed speech therapy system uses a series of graduated speaking exercises with incrementally increasing conversational realism, during which users are expected to anticipate and experience fluency.

As in the Hollins program, the proposed speech therapy system provides intensive therapy and uses computers. However, the use of computers by the Hollins program uses computers for biofeedback training, whereas the proposed system uses computers for speech-to-text translation, audio/visual communication and presentation, facial animation, and to create and enable conversations between the user and other entities. These other entities include artificial conversation modules and humans. The proposed system also eliminates the Hollins program's intensive training by a speech therapist, and the Hollins program's travel and housing costs. Moreover, unlike the Hollins program, the proposed system makes absolutely no effort to “educate” users about how to change their speech patterns to achieve fluency. In fact, a foundational basis for the proposed system is that people who stutter already know how to speak fluently, since the speech of people who stutter is remarkably fluent when they are completely alone.

The proposed speech therapy system also uses VR technology. However, unlike current VR technology-based approaches to improve fluency, the proposed system places conditions upon the use of VR technology, and employs the technology to increase conversational stress over time. In one example, the proposed system ensures a level of fluency of the users before they speak to a VR audience. In contrast, the current VR technology-based approaches do not gauge or otherwise ascertain a level of fluency of the users, and the users thus experience their current level of disfluency ab initio.

Users of the proposed system are first led through a considerable number of defined speaking exercises (about ten GSEs) in sequence, well before encountering GSEs that include VR technology. The first ten GSEs require that the user be fluent before they begin the VR-based GSEs. In a preferred implementation, the proposed system does not expect the fluency of users to improve, per se, during the VR-based GSEs. Rather, subsequent VR-based GSEs in the sequence are configured to maintain the same level of user fluency, but with increasing levels of conversational stress placed upon the user.

Once the proposed speech therapy system is in an app state associated with a VR-based GSE, the proposed system provides additional advantages over the current VR technology-based approaches. In one example, the proposed system, via its successive GSEs, is configured to provide an incremental progression of fluency anxiety/environmental stress across successive VR-based GSEs. Here, the number, age, sex, and social status of the VR audience members may be adjusted in successive VR-based GSEs to move progressively from low-stress audiences (young, few-in-number, same sex as the user) to high-stress audiences (older, more numerous, wearing business attire, with mixed sexes). In another example, the venue of the speaking environment may be configured to progressively transition from a lower stress venue such as a living room, to a moderate stress venue such as a conference room at a business, and ultimately to a high stress venue such as an auditorium. In still another example, audiences of earlier VR-based GSEs may be configured to be ‘passive’, i.e., silent, whereas audiences of later VR-based GSEs in the sequence may be configured to be increasingly ‘active’ or participatory. Here, the VR audience members might pose questions to the user based on what the user has said. These questions might be generated by AI modules, in response to receiving the user speech as input, in one example.

The proposed speech therapy system also leverages the decreasing cost of VR technologies due to their maturity. This also increases the value proposition of the proposed system. The proposed system is compatible with VR headsets such as the Meta Quest VR headset that ranges in cost from about $300 to $500 USD when new. The VR software required to generate reasonably realistic virtual audiences on the VR headsets, or on other VR-enabled displays, also has a very reasonable monthly fee. In one example, company VRSpeaking, LLC sells its Ovation VR virtual audience software service for as little as $15 USD per month as of May 2025. In examples, the Ovation VR software can generate virtual audiences in twelve venues, ranging from a boardroom to a conference hall; the size and makeup of the audience is configurable; the audience's attire and attitude are configurable; and various audience members smile, clap, ask questions, and even occasionally become distracted by their cellular phones.

Other technologies that enhance the capabilities of the proposed speech therapy system include inexpensive, speech-to-text (STT) and text-to-speech (TTS) software modules. These modules have benefitted greatly from recent advances in artificial intelligence. In the proposed speech therapy system, the STT modules are routinely employed to transcribe user speech so that its transcription (but not the original audible user speech) can be transmitted to human remote conversation partners (RCPs) in video conference calls, in one example.

The TTS modules, in one example, can be in the form of a choral reader module (choral reader) that accepts a text passage as input, and outputs a synthetic choral reader speech signal. The choral reader can then present the speech signal audibly at headphones worn by the user or at a speaker. The user can then recite the same text passage while simultaneously hearing the audible version from the choral reader. This is also known as “user recitation of text in unison with the choral reader”, which is known to dramatically improve the fluency of people who stutter. In another example, a TTS module is also used in at least one GSE to reconstruct the transcription of user speech back into a synthetic audio signal in a cloned voice. In this way, only the synthetic cloned speech (and not the user's original audible speech) can be transmitted to RCPs in video conference calls.

In general, according to one aspect, the invention features a speech therapy system. The speech therapy system comprises graduated speaking exercise modules, also known as GSE modules, and a computer system including a processor and a memory. The GSE modules are each configured to provide a graduated speaking exercise, also known as a GSE, for a stuttering user, where the GSE modules are arranged sequentially to provide GSEs of increasing conversational realism from each GSE to a next GSE in the sequence. The computer system is configured to load a fluency management application, also known as an app, into the memory for execution by the processor, and to load the GSE modules into the memory for execution by the app. Upon execution of the GSE modules, the app creates a GSE for each GSE module that defines a different state of the app.

When the app is in a current app state defined by a current GSE, the app is configured to: 1) either present at least one text passage to the user and prompt the user to recite the text passage aloud, where the recitation of the text passage forms user speech, or 2) enable the user to speak aloud extemporaneously with another person or with a software entity. Here, the user extemporaneous speech forms the user speech, and the user extemporaneous speech or a transcription thereof is transmitted by the app to the other person or to the software entity. Then, upon the app determining that the user speech at least meets a fluency threshold of the current GSE, the app recommends that the user transition to a next app state associated with a next GSE of the current GSE. When the app is in a final app state defined by a final GSE, upon the app determining that the user speech during the final GSE at least meets a fluency threshold of the final GSE, the app concludes that the user is fluent and notifies the user in response.

In one example, the app determines that the user speech at least meets the fluency threshold of the current GSE by obtaining a fluency metric based upon the user speech, and the app obtains the fluency metric by either: 1) receiving a fluency self-rating provided by the user, where the fluency self-rating is the fluency metric; 2) presenting a fluency challenge test to the user, requesting the user to recite words in the challenge test, and receiving a fluency score from the user based upon the user speech during the challenge test, where the fluency score is the fluency metric; or 3) passing the user speech as input to a fluency monitor module that is loaded into the memory and executed by the processor, where the app sends an audio signal representation of the user speech as input to the fluency monitor module, and where the fluency monitor module calculates the fluency metric as output.

The speech therapy system might include an artificial neural network module that is loaded into the memory and executed by the processor. Here, during an app state associated with at least one GSE, the app might pass a list of problem words as input to the artificial neural network module, and direct the artificial neural network module to create a sanitized text passage that excludes one or more of the problem words. The artificial neural network module might present the sanitized text passage to a monitor of the computer system for the user to recite aloud, where the recitation of the sanitized text passage by the user forms the user speech.

The speech therapy system might also include a sanitized text driver module that is loaded into the memory and executed by the processor. The sanitized text driver module accesses the list of problem words and is in communication with the artificial neural network module. The sanitized text driver module can direct the artificial neural network module to generate the sanitized text passage that excludes the one or more of the problem words. In one implementation, the artificial neutral network module creates the sanitized text passage by: accessing a stored text passage from the memory; rewriting the stored text passage into a rewritten text passage that removes one or more of the problem words and is designed to convey a similar meaning as the stored text passage; and providing the rewritten text passage as the sanitized text passage.

The speech therapy system might include an artificial conversation module that is loaded into the memory and executed by the processor. The artificial conversation module receives as input either an audio signal representation of the user speech or a text-based representation of the user speech, generates conversational responses to the input, and presents the conversational responses to a video monitor or a speaker of the computer system.

The speech therapy system might include a speech-to-text module, also known as an STT module, that is loaded into the memory and executed by the processor. The STT module receives an audio signal representation of the user speech from the app as input and outputs a text-based representation of the user speech. For at least one GSE, the app then sends the text-based representation of the user speech to a human conversational partner on a remote computer system.

Additionally, the human conversational partner might provide audio responses to the text-based representation of the user speech. The remote computer system sends audio signal representations of the audio responses to the app of the user computer system, and the app presents the audio signal representations to speakers or a headset connected to the user computer system. Additionally, the human conversational partner might provide text responses to the text-based representation of the user speech. The remote computer system can then transmit text-based representations of the human conversational partner's responses to the app, and the app can present the text-based responses to a video monitor of the user computer system.

The app might also create an audio recording of the user speech, and send the recording to a human conversational partner on a remote computer system upon receiving an indication of approval from the user. The app might also send audio signals of the user speech to the remote human conversational partner on the remote computer system. Typically, the remote human conversational partner responds with audible speech, and the remote computer system sends audio signal representations of the audible speech to the app of the computer system.

In another example, the computer system transmits the user speech to one or more remote human conversational partners on remote computer systems, and the computer system transmits image data of the user captured by a video camera to the one or more remote human conversational partners at the remote computer systems. The remote computer systems might then present the image data to monitors of the remote computer systems. Alternatively, the computer system transmits the user speech to the one or more remote human conversational partners on the remote computer systems, and video cameras connected to the remote computer systems capture image data of the remote human conversational partners. The remote computer systems transmit the image data of the remote human conversational partners to the user computer system, and the app presents the image data of the remote human conversational partners to a video monitor of the computer system.

The speech therapy system might also include a video monitor connected to the computer system, and an avatar generator module loaded into the memory and executed by the processor. For at least one GSE, the avatar generator module is configured by the app to render an avatar representing the user and to present the avatar to the video monitor, and to optionally send the avatar to a human conversational partner on a remote computer system.

Preferably, each of the GSEs includes a lower fluency threshold and an upper threshold. When the app determines that a fluency metric obtained from the user speech is greater than the lower fluency threshold of the GSE that defines the current app state but less than the upper fluency threshold of the GSE that defines the current app state, the app is configured to remain in the current app state. Additionally, when the app determines that the fluency metric is less than the lower fluency threshold of the GSE that defines the current app state, the app is configured to transition to a previous app state associated with a previous GSE of the GSE that defines the current app state.

Typically, each GSE includes a minimum conversation time for the user speech. When the app determines that the user speech has occurred over a time period that is less than the minimum conversation time of the GSE that defines the current app state, the app is configured to remain in the current app state.

In yet another example, each GSE includes an upper fluency threshold and a minimum conversation time for the user speech. When the app determines that 1) the user speech has occurred over a time period that is greater than the minimum conversation time of the GSE that defines the current app state, and 2) a fluency metric obtained from the user speech at least meets the upper fluency threshold of the GSE that defines the current app state, the app is configured to transition to the next app state associated with the next GSE of the GSE that defines the current app state.

The speech therapy system might also include a virtual reality device, also known as a VR device, worn by the user. For at least one GSE, the app is configured to present image data of a virtual audience to a display of the VR device, while the user is reciting the user speech. Here, members of the virtual audience do not respond verbally to the user speech. Alternatively, for at least one GSE, the app is configured to present image data of the virtual audience to the display of the VR device, and one or more members of the virtual audience respond verbally to the user speech.

In yet another example, for at least one GSE, the app receives an audio signal representation of the user speech, and divides the audio signal representation into a plurality of audio snippets that each include one or more words of the audio signal representation of the user speech. The app transmits at least a subset of the audio snippets to a remote human conversational partner on a remote computer system. The remote human conversational partner provides audio responses to the audio snippets, the remote computer system sends audio signal representations of the responses to the app of the computer system, and the app presents the audio signal representation of the responses to speakers or to a headset of the computer system.

The speech therapy system might also include a choral reader module that is loaded into the memory and executed by the processor. The choral reader module is configured to receive a text passage as input from the app, and to generate an audio signal representation of the text passage, also known as a choral reader audio signal, as output. For at least one GSE, the choral reader audio signal is presented audibly to the user, and the user recites the text passage aloud in unison with the presented choral reader audio signal.

Generally, one or more GSEs include characteristics which are designed to increase or decrease fluency anxiety in the users, and the characteristics are configurable by the user.

In general, according to another aspect, the invention features a method for a speech therapy system. The method comprises graduated speaking exercise modules, also known as GSE modules, each providing a graduated speaking exercise, also known as a GSE, for a stuttering user, where the GSE modules are arranged sequentially to provide GSEs of increasing conversational realism from each GSE to a next GSE in the sequence. The method also comprises loading a fluency management application, also known as an app, into a memory of a computer system, and executing the app via a processor of the computer system. The method further comprises loading the GSE modules into the memory, and executing the GSE modules via the app, where upon execution of the GSE modules, the app creates a GSE for each GSE module that defines a different state of the app.

When the app is in a current app state defined by a current GSE, the app either: 1) presents at least one text passage to the user and prompts the user to recite the text passage aloud, where the recitation of the text passage forms user speech; or 2) enables the user to speak aloud extemporaneously with another person or with a software entity, where the user extemporaneous speech forms the user speech, and where the user extemporaneous speech or a transcription thereof is transmitted by the app to the other person or to the software entity. Then, upon the app determining that the user speech at least meets a fluency threshold of the current GSE, the app recommends that the user transition to a next app state associated with a next GSE of the current GSE. When the app is in a final app state defined by a final GSE, upon the app determining that the user speech during the final GSE at least meets a fluency threshold of the final GSE, the app concludes that the user is fluent and notifies the user in response.

In general, according to yet another aspect, the invention features a fluency system. The fluency system includes a computer system including a processor and a memory; a video conference application loaded into the memory and executed by the processor; a speech to text module, also known as a STT module, loaded into the memory and executed by the processor; a text to speech module, also known as a TTS module, loaded into the memory and executed by the processor; and an avatar generator module loaded into the memory and executed by the processor.

In more detail, the video conference application is configured to establish a video conference session between a user of the computer system and at least one remote human conversational partner at a remote computer system. For this purpose, the video conference application establishes the video conference session between the video conference application and a remote video conference application on the remote computer system, where the session is established over a network, such as a private network or a public network (e.g., the Internet). The STT module is configured to receive, as input, an audio signal representation of user speech from a microphone of the computer system, and to produce, as output, a text stream of the user speech. The TTS module is configured to receive, as input, the text stream of the user speech from the STT module, and to produce, as output, reconstituted audio signals of the user speech.

The avatar generator module is configured to: 1) receive, as input, image data of the user captured by a video camera of the computer system, and the reconstituted audio signals of the user speech; and 2) to produce, as output, video signals of an avatar representing the user and the reconstituted audio signals, where the video signals of the avatar include animated lip and facial expressions of the user based upon the image data and/or the reconstituted audio signals. The output video signals of the avatar and the output reconstituted audio signals collectively form a fluent digital twin of the user, which the avatar generator module sends to the video conference application. The video conference application then sends the fluent digital twin of the user over the video conference session to the at least one remote human conversational partner.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B show a schematic diagram of an exemplary speech therapy system including a computer system, according to a preferred embodiment, where the figures show a fluency management application (“app”) and a set of modules of the computer system, and where FIG. 1B shows additional modules that could not be shown in FIG. 1A;

FIG. 2 is a schematic diagram which shows detail for graduated speaking exercise modules (GSE modules) in the speech therapy system of FIGS. 1A and 1B, and shows that the app executes each GSE module to create an associated graduated speaking exercise (GSE) for each GSE module, where each GSE also defines a different state of the app and thus a different state or step of the speech therapy system;

FIG. 3 is a table that includes an exemplary list of 31 GSEs, configured for use in a speech therapy system constructed in accordance with principles of the present invention, and includes a summary description of each;

FIG. 4 is a table that provides more detail for the configuration of hardware and software components in each of the 31 GSEs described in FIG. 3;

FIG. 5 is a schematic diagram of the speech therapy system which shows modules enabled during a first GSE of the system, GSE A-1;

FIG. 6 is a schematic diagram of the speech therapy system, which shows modules enabled during exemplary GSE B-6;

FIG. 7 is a sequence diagram that describes operation of the speech therapy system in FIG. 6;

FIG. 8 is a schematic diagram of the speech therapy system, which shows modules enabled during exemplary GSE A-10;

FIG. 9 is a schematic diagram of the speech therapy system, which shows modules enabled during exemplary GSE C-3;

FIG. 10 is a schematic diagram of the speech therapy system, which shows modules enabled during exemplary GSE B-8;

FIG. 11 is a schematic diagram of the speech therapy system, which shows modules enabled during exemplary GSE A-12;

FIGS. 12A-12C are flowcharts that illustrate operation of the app for processing a software promotions module, where: FIG. 12A shows processing of a self-reported fluency from the user as the fluency metric; FIG. 12B shows processing of a fluency score from the user as the fluency metric; and FIG. 12C shows processing of fluency statistics as the fluency metric, where the fluency statistics are determined from an audio representation of user speech;

FIG. 13 is a flowchart that describes how the app can be configured to receive all three of the different fluency metrics in FIG. 12A-12C as inputs, and to apply a weighting scheme to the inputs during processing;

FIG. 14 is a sequence diagram that shows an exemplary configuration of the speech therapy system, which shows modules enabled during exemplary GSE A-3, and further illustrates the processing of problem words identified by the user;

FIG. 15 is a schematic diagram of a speech therapy system, according to another embodiment, where the system includes components that provide or otherwise form a fluent digital twin of the user;

FIG. 16 is a schematic diagram of a speech therapy system that produces a voice clone of the user's speech, where the voice clone is a likeness of the user's voice as perceived by the user;

FIG. 17 is a manager screen of the app presented in a graphical user interface (GUI), where the screen enables the user to monitor and control operation of the GSEs in the speech therapy systems, and where the configuration settings for GSE A-9 in FIGS. 3 and 4 are displayed;

FIG. 18 shows details of a graduated speaking exercise in the GUI, displayed in response to selection of a “display GSE details” button shown in FIG. 17 for exemplary GSE A-9;

FIG. 19 shows details of a promotion manager control screen of the GUI that shows statistics of the current GSE and recommends a promotion decision, where the screen includes sample contents displayed in response to user selection of a “request promotion” button for GSE A-9 shown in FIG. 17;

FIG. 20 shows details of a fluency statistics screen of the GUI, displayed in response to selection of a “display statistics”button for GSE A-9 in FIG. 17;

FIG. 21 shows details of exemplary GSE A-4 in the GUI;

FIG. 22 shows more detail for the computer system and its components; and

FIG. 23 shows yet another embodiment of a speech therapy system, where at least some software modules of the system are included in a cloud service application hosted by a cloud service provider.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

By way of background, stuttering research over the past 80 years has identified a considerable number of conditions that can affect the severity of stuttering among people who stutter, including some conditions in which people who normally stutter achieve near-perfect fluency. Recent technological advances including artificial intelligence make it possible to immerse speakers in some combinations of these fluency-favorable conversational environments at low cost.

During operation of the disclosed speech therapy system, the system is configured to incrementally transition from unnatural but fluency-favorable conversational environments or conditions to more realistic conversational environments or conditions. The six most important conditions that affect fluency which are exploited in this proposed speech therapy system are: (1) private-speech and “speaking while alone”; (2) reciting text in unison with a (software-based) reader which is configured to recite the same text; (3) reciting text that is fluency ‘sanitized’, in the sense that the text contains no words that a user has identified as being fluency-problematic; (4) controlling the ‘presence’ of a speaker's audience; (5) controlling the ‘presence’ of the speakers themselves to the speakers'audience; and (6) providing conversational responses to user speech that are generated by artificial-intelligence software rather than spoken by another person.

Examples of controlling the ‘presence’ of a speaker's audience might include: controlling content of audio and/or video signals sent to a user from one or more RCPs, via video conference calls; allowing the user to receive video signals (but not audio signals) from one or more RCPs; and controlling the number, sex, age, and social status of audience members in ‘virtual’ audiences that are generated by Virtual Reality modules. In a similar vein, examples of controlling the ‘presence’ of the speakers themselves might include: controlling content of audio and/or video signals transmitted from the users to one or more RCPs, via video conference calls; and transmitting “sanitized” versions of user speech (rather than the user's original speech) in the audio signals sent from a user to the RCPs.

The disclosed speech therapy system is constructed to maximize the probability that the stuttering user remains fluent throughout all of the steps of the system, beginning at a first GSE/first app state (first step). In fact, if a user experiences inadequate fluency during a speaking exercise of a GSE module, the user will be “demoted” to a previous GSE/app state, in which the user previously experienced a threshold level of fluency. Alternately, if a user experiences inadequate fluency during a GSE, the speech therapy system may allow the user to modify some of the GSE module's features to reduce the level of conversational rigor in the GSE. This correspondingly reduces the level of fluency anxiety experienced by the user during the GSE.

Ensuring that the user remains nominally fluent throughout the speaking exercises of each step also greatly reduces the speaking and psychological stress on the user, as compared to the existing speech therapies. When the app is in a final app state defined by a final GSE (final step of the system), if the app determines that the user has achieved fluency, the app concludes that the user is fluent and notifies the user in response.

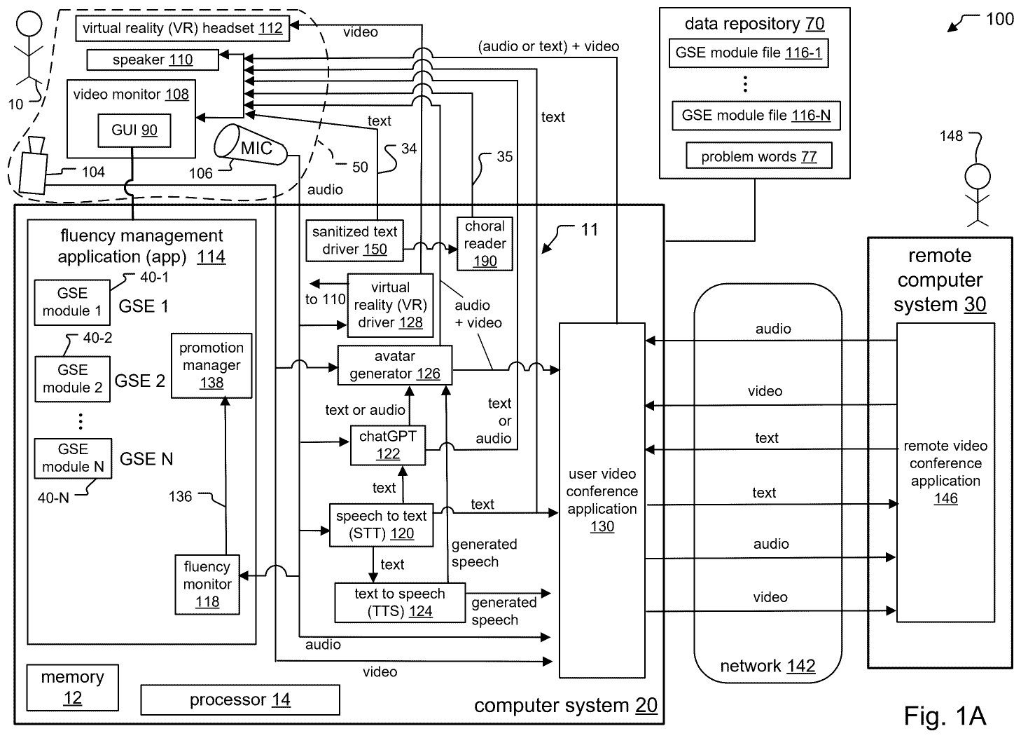

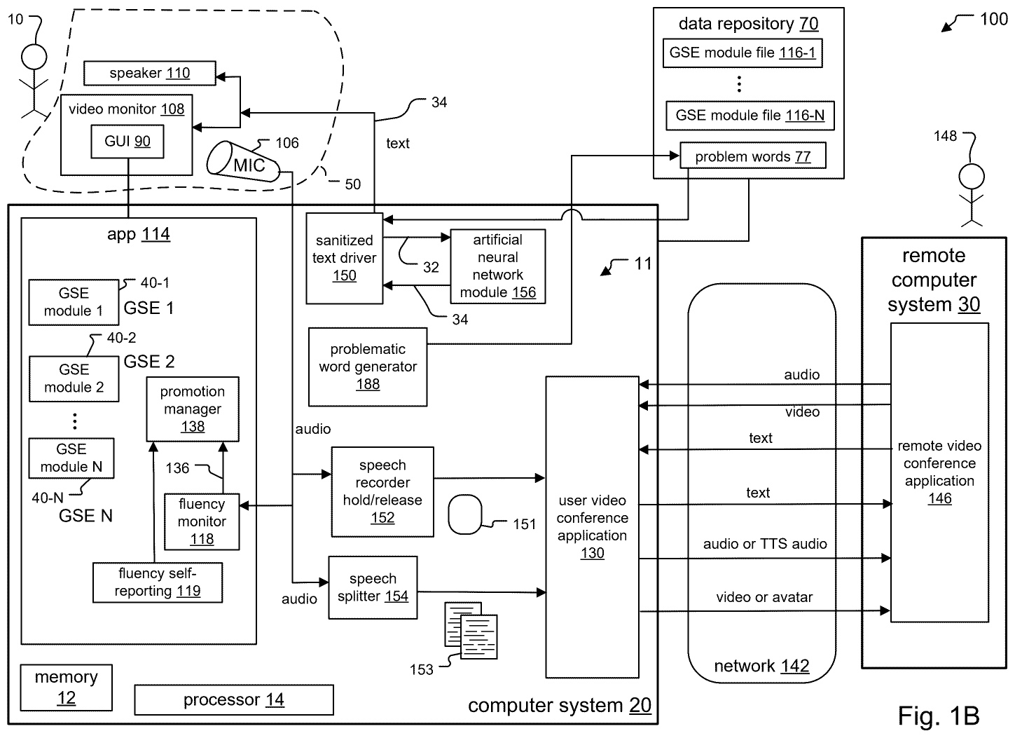

Turning to the figures, FIG. 1A shows a preferred embodiment of a speech therapy system 100 for a user 10. The speech therapy system 100 includes a data repository 70, a computer system 20 and a remote computer system 30. The system 100 additionally includes hardware peripherals 50 such as a virtual reality headset 112, a speaker 110, a video monitor 108, a microphone (MIC) 106 and a video camera 104. The computer system 20 and the remote computer system 30 communicate over a network 142.

It is important to note that although the system 100 comprises a considerable number of hardware components and modules, only a subset of the components and modules will be configured and activated for individual GSEs.

The computer system 20 includes various components. These components include a fluency management application (app) 114, a memory 12, and a processor 14. Additional components include various modules 11. The modules 11 include GSE modules 40, a promotion manager 138, a fluency monitor 118, a virtual reality driver 128, an avatar generator module 126, a sanitized text driver 150, an artificial conversation module (shown as chatGPT module 122), a user video conference application 130, and a choral reader 190. Additional modules include a speech-to-text (STT) module 120 and a text-to-speech (TTS) module 124.

The data repository 70 includes GSE module files 116 and a set of problem words 77. GSE module files 116-1 . . . 116-N are shown. Each GSE module file 116 includes specification data that completely defines the hardware and software configuration of the app 114. An associated GSE module 40-1 . . . 40-N is created in the memory 12 from each GSE module file 116-1 . . . 116-N. The app 114 then executes each GSE module 40-1 . . . 40-N to create an associated GSE 1 . . . GSE N that each define a different state of the app 114.

The specification data in each GSE module file 116 at least includes: (1) a list of the many available hardware and software components that are activated in the corresponding GSE module 40; (2) an origin and destination of signals that are generated by the active components in the GSE module 40; (3) crucially, a list of software components and/or humans who can hear the user's speech in the GSE module 40; and (4) data and/or business logic that informs a decision to promote a user 10 to a next more-realistic conversation environment defined by a next GSE, to remain in the current GSE, or to demote to a previous, less-realistic conversation environment provided by a prior GSE.

The computer system 20 is configured to load the app 114 into the memory 12 for execution by the processor 14, and to load the GSE modules 40 into the memory 12 for execution by the app 114. Here, upon execution of the GSE modules 40 by the app 114, each of the GSE modules 40 creates a GSE that defines a different state of the app 114.

The app 114 also creates a graphical user interface (GUI) 90 and presents it to the user 10 via the video monitor 108. The app 114 presents the GUI 90 to the user 10 during each of the GSEs, and upon completion of each GSE.

The network 142 might be a public communications network such as the Internet, a private or leased network, or other network. The network 142 might include or otherwise be in communication with one or more cloud-based network computing services such as Amazon AWS, IBM Cloud and Google Cloud, in examples. AWS is a registered trademark of Amazon, Inc. and IBM Cloud is a registered trademark of IBM, Inc.

A user 10 of the speech therapy system 100 is also shown. The user 10 might wear the virtual reality headset (VR headset) 112 and speak into the MIC 106. The user 10 interacts with the app 114 and can send information to and receive information from the system 100 via the video monitor 108, such as via the GUI 90. The video camera 104 captures image data of the user 10, and the speaker 110 (or earphone, headphone device worn by the user) presents audio to the user 10.

The speech therapy system 100 strongly suggests that the user 10 refrain from normal conversations with other humans for the duration of the therapy beyond the structured speaking exercises that comprise the therapy itself. Normal conversation could immerse the stutterer in high-stress speaking situations that risk relapse into an anticipation of disfluent speech. It is noted that this requirement of no audible conversations with humans during the therapy differentiates the present therapies from most other stuttering therapies, which do not impose such a limitation. This hermit-like requirement of no in-person conversations during the course of the program may be relaxed if clinical testing shows that it is not necessary. To maintain human contact during the program, users are encouraged to reach out to friends and family using electronic mail and social media, so long as their speech is not heard by other people.

More detail for the computer system 20 is as follows. The modules 11 are either software or firmware modules or data structures. In a preferred embodiment, with the exception of GSE modules 40-1 thru 40-N (where GSE module 40-1 is A-1; GSE module 40-14 is B-1, GSE module 40-22 is C-1, and GSE module 40-30 is D-1), the modules 11 are either software of firmware modules which are read into the memory 12. In a preferred embodiment, the GSE modules 40-1 thru 40-N are in the form of data structures which are read into the memory 12 from the GSE module files 116 in the data repository 70. The data structures include statements in an interpreted language such as Perl or Python, in examples, and include data or references to data. When the data structures are compatible with Python, in one example, the data structures might be data ‘dictionaries’ that include statements that bind variable names to values (e.g., variable name “GSE_minimum_hours” to value 6.5). The statements and data in each module 11 might be accessed and used by other modules 11 to carry out specific tasks.

The modules 11 may also be in the form of libraries, stand-alone executable code or the like. The modules 11 are loaded into the memory 12 by an operating system (not shown), and scheduled for execution by the processor 14. The app 114 and the user video conference application 130 are also loaded into the memory 12 and scheduled for execution by the processor 14.

In the illustrated example, according to one implementation, GSE modules 40-1. 40-N are shown included within the app 114, and the promotion manager 138 and the fluency monitor 118 are also shown included within the app 114. The remaining modules 11 are shown outside of the app 114.

Additionally or alternatively, one or more of the modules 11 and/or the app 114 might reside on the network 142, such as a in a cloud-based network. At the same time, the user video conference application 130 must reside within the local computing device 20 to manage the transmission and reception of audio and video signals to/from remote video conference applications 146 of remote computer systems 30.

The speech therapy system 100 is arranged as follows. The computer system 20 and the remote computer system 30 communicate with each other over the network 142. For this purpose, the user video conference application 130 and the remote video conference application 146 each interface with the network 142.

The data repository 70 connects to the computer system 20. In the illustrated example, the data repository 70 is shown as having a direct connection to the computer system 20, where the data repository might be a disk drive or other storage device of the computer system 20, in examples. Additionally and/or alternatively, the data repository 70 might connect to the network 142.

Within the app 114, the fluency monitor 118 receives audio from the MIC 106.

Here, the audio is an audio signal representation of speech from the user (user speech). The fluency monitor 118 gathers or otherwise obtains fluency statistics 136 based on the audio signal representation of user speech and sends the fluency statistics to the promotion manager 138.

The artificial conversation module/chatGPT module 122 has multiple inputs and outputs. It can receive an audio representation of user speech from the MIC 106, or receive text from the STT module 120. The chatGPT module 122 outputs either text or audio in response. The output of the chatGPT module 122 connects to the input of the avatar generator 126, the speaker 110 and the video monitor 108.

The virtual reality driver 128 generates video and optionally audio as its output(s). The virtual reality driver 128 connects to and sends the video to the VR headset 112 and/or to the video monitor 108. The virtual reality driver 128 can optionally send audio to the speakers 110. The video generated and sent to the video monitor 108 is typically in the form of a two dimensional (2D) virtual audience of individuals, while the video generated and sent to the VR headset 112 is typically in the form of a three dimensional (3D) virtual audience of individuals. While the 2D output is less realistic than the 3D output, the 2D output has the advantage of cost savings. In one implementation, via the GUI 90, the user 10 can select whether to receive the 2D video at the monitor 108, the 3D video at the VR headset 112, or both the 2D and the 3D video.

The virtual reality driver 128 can also be configured to create virtual audiences with different characteristics, including the number of audience members, their ages, sex, and social status. The venue of the speaking exercise is likewise configurable, ranging from low fluency-anxiety provoking venues like a home living room to a high fluency-anxiety provoking venue like a large auditorium. Some commercial VR audience generation services also allow the audience members to be ‘active’, i.e., an embedded artificial intelligence conversation engine creates verbal responses based on its received user speech, and these verbal responses are ‘spoken’ by one of the audience members.

The avatar generator 126 has three inputs and two outputs. The avatar generator 126 can receive image data of the user 10 from the video camera 104, and text or audio from the chatGPT module 122, and an audio signal from the TTS module 124. The output of the avatar generator 126 connects to the user video conference application 130, to the user's speaker 110 and to the video monitor 108.

The sanitized text driver 150 is an artificial intelligence-based software module that can generate a text passage on a topic of interest. The sanitized text driver 150 generates or otherwise provides text passages that have a reduced frequency of problem words 77 relative to their natural occurrence frequency in the language of the user. For this reason, the text passages generated or provided by the sanitized text driver 150 are also known as sanitized text passages 34. Ideally, each sanitized text passage 34 includes none of the problem words 77. Typically, the sanitized text driver 150 periodically performs a lookup of the problem words 77 in the data repository, and generates text for a requested topic of interest that does not include any of the problem words 77. At the same time, the sanitized text driver 150 can be configured to generate ‘unsanitized’ text passages that do not preclude the use of any words in the text passages that it generates.

The STT module 120 has a single input and multiple outputs. It can receive an audio representation of user speech from the MIC 106, and provide a text representation of the user speech as output to the user video conference application 130, the video monitor 108, the chatGPT module 122 and the TTS module 124, in examples.

The TTS module 124 has a single input and multiple outputs. The TTS module 124 can receive text from the STT module 120. The TTS module 124 provides generated speech as output to the user video conference application 130, and the avatar generator 126, in examples.

The choral reader 190 has a single input and a single output. The choral reader 190 receives a text passage in electronic format, which optionally can be ‘sanitized’ to omit a user's self-identified fluency-problematic words. The choral reader 190 then generates an audio signal containing a synthetic speech rendition of the text passage in a ‘cloned’ voice, which is transmitted to the user's audio output device, either via the computer speakers 110 or the headset 112. A voice clone is preferably a likeness or synthetic version of the user's voice, as perceived by the user. Alternatively, the voice clone can be in a voice that is different from that of the user 10, such as in a different pitch (higher or lower).

The speech therapy system 100 generally operates as follows. At initialization, the app 114 is loaded into the memory 12 and executed by the processor 14. The app 114 reads the GSE module files 116-1 . . . 116-N and the problem words 77 from the data repository 70 and stores the data contents of the files 116 in memory 12. The GSE module files 116-1. 116-N each define the contents of a corresponding GSE module 40-1 . . . 40-N. The app 114 executes instructions to activate particular modules 11 as defined by the current GSE module 40 in memory.

In one implementation, just after the GSE modules 40 are created in the memory 12, the app 114 examines a data specification of each of the GSE modules 40 to identify all other modules 11 that the GSE modules 40 reference (i.e., invoke, access, or otherwise communicate with) during operation of the system 100. The app 114 loads all of the referenced modules 11 into the memory. Once the GSE modules 40 are loaded in memory, the app 114 loads and executes instructions based on the data specification of the first GSE module 40-1 to create a first GSE (GSE 1) that defines a first app state.

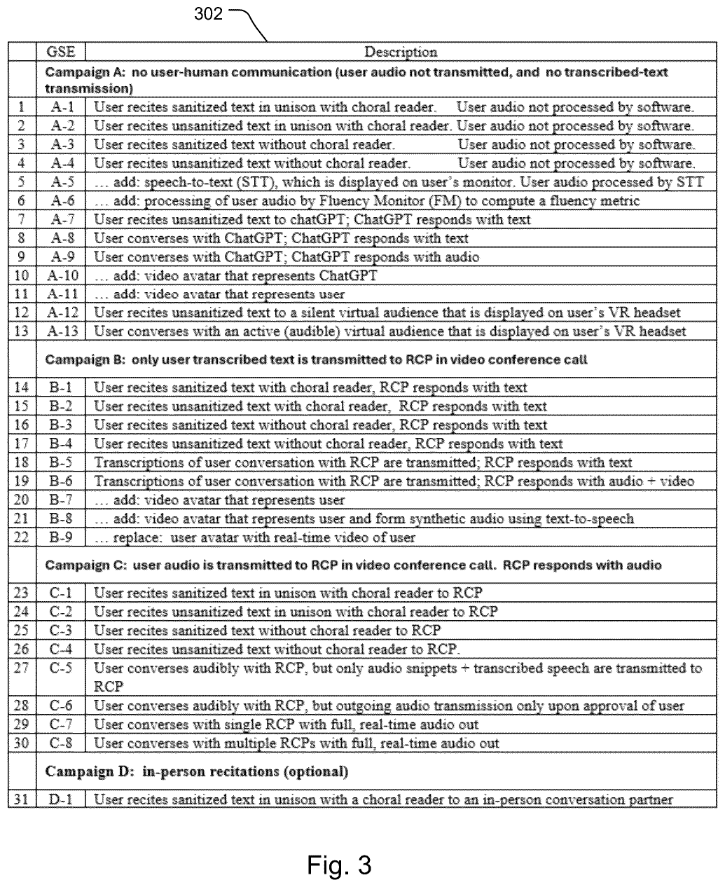

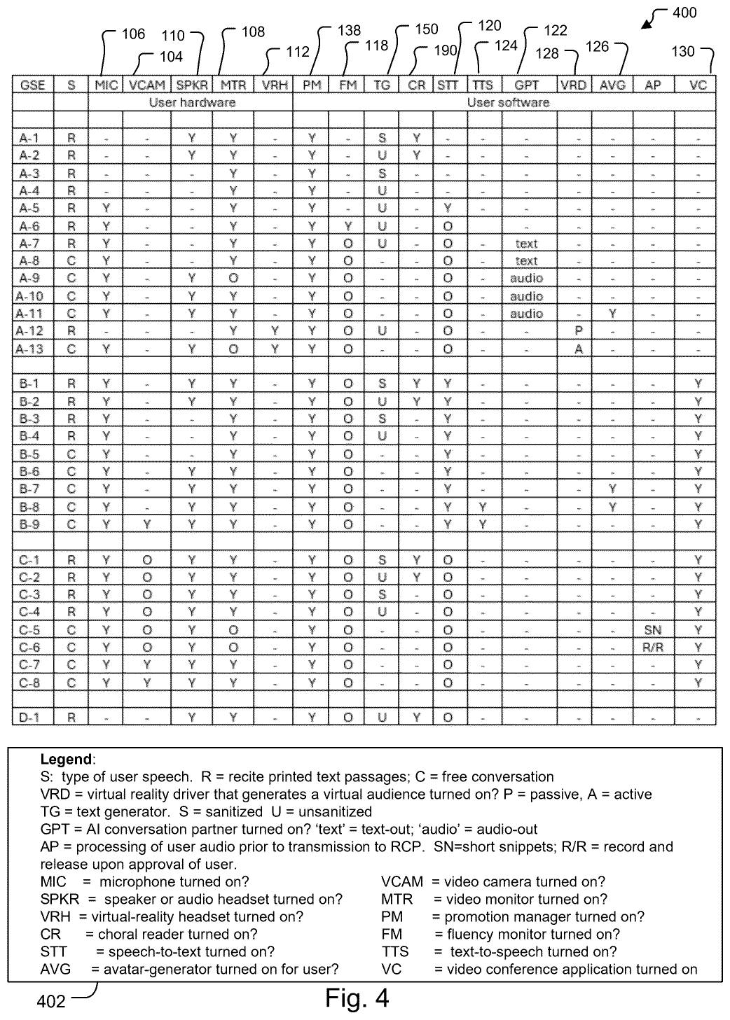

The first app state defined by GSE A-1 has the least amount of conversational realism of all app states/GSEs in the system 100. Here, the user defines a topic of interest and the sanitized text driver 150 generates sanitized text passages 34 based upon the topic. The user is instructed to recite the text in unison with a synthetic ‘choral reading’ rendition of the same text that is generated by the choral reader 190. More detail for the first GSE, GSE A-1, is included in FIGS. 3 and 4, the descriptions of which are included hereinbelow.

When the app 114 is in a current app state defined by a current GSE, the app 114 is configured to obtain or determine a fluency metric from words spoken by the user during the speaking exercises, also known as user speech, and to possibly determine whether the fluency metric at least meets the upper fluency threshold 224 of the current GSE. Upon determining that the fluency metric at least meets the upper fluency threshold 224, the app 114 is configured to transition to a next app state associated with the next GSE of the current GSE. Then, when the app 114 determines that the fluency metric meets the upper fluency threshold 224 of a final app state defined by a final GSE, the app 114 concludes that the user 10 is fluent and notifies the user 10 in response.

The creation and management of the set of problem words 77 is a two-step process. An initial set of problem words 77 is created through user interaction with the app 114, via the GUI 90. In one implementation, the app 114 presents a listing of the most commonly used words in the language of the user 10 to the user, via the GUI 90 on the video monitor 108, along with one radio button for each word. The user indicates which words are fluency-problematic for him or her by clicking on those words'radio buttons, the result of which adds the words to the list of problem words 77. In an alternate implementation, the app 114 constructs a text passage which the user recites aloud, the user's speech is recorded, and additionally the user's speech is transcribed into text by the STT module 120. Upon completion of recitation, the user's recorded speech is replayed on the speaker 110, and simultaneously the text is displayed on the video monitor 108. Through listening to the recorded speech, the user identifies the stuttered words, and records them by clicking on the corresponding words in the text of the transcribed speech.

The set of problem words 77 can also be updated by the user 10. Experience has shown that the app 114 sometimes does not identify all the words stuttered by the user 10. For this reason, the GUI 90 provides a mechanism for the user to edit the list of problematic words 77. The user 10 can add words to and delete words from the set of problematic words 77 throughout the course of the program.

Once the user 10 is in the fifth step (GSE A-5) of the system 100 as defined in FIGS. 3 and 4, the instructions and rules of GSE A-5 specify that one or more additional modules 11 be executed. In one example, GSE A-5 specifies that the user audio signal captured by the MIC 106 is processed by the STT module 120 and the transcribed text is displayed on the monitor 108. In another example, GSE A-6 specifies that the fluency monitor 118 is executed. Additionally, GSE A-6 also configures the promotion manager 138 to accept additional inputs for determining whether the user has achieved fluency. In the illustrated example, the fluency monitor 118 receives an audio representation of the user speech from the MIC 106 as input, and generates fluency statistics 136 based upon the audio representation of the user speech. The promotion manager 138 can then determine the fluency of the user 10 based upon the fluency statistics 136 in addition to a self-report of fluency by the user.

In the illustrated example, all steps of the system 100 from GSE A-6/step 6 onward specify that the promotion manager 138 determine fluency of the user 10 based at least upon the fluency statistics 136 obtained or otherwise generated by the fluency monitor 118. However, if users report that having an app 114 rate their fluency creates too much linguistic/stuttering anxiety, an alternate implementation can be constructed in which the fluency monitor 118 is turned off.

In some app states defined by their corresponding GSEs, the app 114 may specify that the user engage in conversation with one or more RCPs 148. For this purpose, text and/or or audio representations of user speech of the user 10 are sent to the user video conference application 130. The video conference application 130, in turn, is in communication with a peer application (here, the remote video conference application 146) of each remote computer system 30 to which the RCPs 148 are connected. Video of the user 10 may also accompany the text and/or or audio representations of user speech during these remote communication sessions.

Because the system 100 is designed to change a user's expectation of fluency and for the users to achieve fluency, it would be counterproductive to expose the users 10 to high fluency-stress via in-person conversations before completing the therapy. It is for this reason that users 10 will be encouraged to refrain from audible conversations with other humans during the therapy. This requirement may be a significant social ‘cost’ to the stuttering user. This cost increases as the duration of the therapy increases. Thus, clinical testing is suggested to identify the minimum duration of the therapy which still achieves the ultimate objective of permanently changing a stutterer's expectation of fluent speech (and achieving fluent speech) when conversing audibly with other humans.

In this way, in a preferred embodiment, the speech therapy system 100 is configured to include graduated speaking exercise modules, also known as GSE modules 40, and a computer system 20 including a processor 14 and a memory 12. The GSE modules 40 are each configured to provide a graduated speaking exercise, also known as a GSE, for a stuttering user, where the GSE modules 40 are arranged sequentially to provide GSEs of increasing conversational realism from each GSE to a next GSE in the sequence. The computer system 20 is configured to load a fluency management application, also known as an app 114, into the memory 12 for execution by the processor 14, and to load the GSE modules 40 into the memory for execution by the app 114. Upon execution of the GSE modules 40, the app 114 creates a GSE for each GSE module 40 that defines a different state of the app 114.

When the app 114 is in a current app state defined by a current GSE, the app 114 is configured to either: 1) present at least one text passage to the user 10 and prompt the user 10 to recite the text passage aloud, where the recitation of the text passage forms user speech, or 2) enable the user 10 to speak aloud extemporaneously with another person or with a software entity. Here, the user extemporaneous speech forms the user speech, and the user extemporaneous speech or a transcription thereof is transmitted by the app 114 to the other person or to the software entity. Then, upon the app 114 determining that the user speech at least meets a fluency threshold of the current GSE, the app 114 recommends that the user 10 transition to a next app state associated with a next GSE of the current GSE. When the app 114 is in a final app state defined by a final GSE, upon the app 114 determining that the user speech during the final GSE at least meets a fluency threshold of the final GSE, the app 114 concludes that the user is fluent and notifies the user in response.

In one example, the app 114 determines that the user speech at least meets the fluency threshold of the current GSE by obtaining a fluency metric based upon the user speech, and the app 114 obtains the fluency metric by either: 1) receiving a fluency self-rating provided by the user, where the fluency self-rating is the fluency metric; 2) presenting a fluency challenge test to the user, requesting the user to recite words in the challenge test, and receiving a fluency score from the user based upon the user speech during the challenge test, where the fluency score is the fluency metric; or 3) passing the user speech as input to a fluency monitor module 118 that is loaded into the memory 12 and executed by the processor 14, where the app 114 sends an audio signal representation of the user speech as input to the fluency monitor module 118, and where the fluency monitor module 118 calculates the fluency metric as output.

FIG. 1B shows more detail for the speech therapy system 100 in FIG. 1A. Specifically, FIG. 1B shows additional modules 11 that could not be shown in FIG. 1A: an artificial neural network module 156, a speech recorder hold/release module (speech recorder) 152, a speech splitter module (speech splitter) 154, a problematic word generator 188 and a fluency self-reporting module 119.

The additional modules 11 are arranged as follows. The sanitized text driver 150 instructs the artificial neural network module 156 to generate text on a chosen topic, indicated by reference 32. Here, the instruction 32 includes the topic, and might also include a list of one or more problem words 77. In response, the sanitized text driver 150 generates sanitized text passages 34 for the topic as output, and the forwards the sanitized text passages 34 to the GUI 90/video monitor 108. The speech recorder 152 and speech splitter 154 software modules receive audio signals representative of user speech from the MIC 106 as input, and include output connections to the user video conference application 130. The speech recorder 152 provides an audio recording 151 as output. The speech splitter 154 generates, as output, brief audio snippets 153 of typically two or three words each. In another example, the audio recording 151 includes two or three sentences of words. The problematic word generator 188 can generate candidate problem words and can update the stored list of problem words 77 with the user-identified problem words.

More detail for the speech recorder 152 and speech splitter 154 is as follows. When the speech recorder 152 is executed in an app state/step of the system 100, the speech recorder 152 records the audible speech of the user 10 into an audio recording 151. However, the speech recorder 152 transmits the audio recording 151 to the video conference app 130 only upon explicit consent of the user 10. This mechanism allows the user to effectively delete any disfluent speech from the audio signal that is transmitted to the remote computer system 30 or RCP 148, thereby reducing the user's anxiety about having his or her stuttered speech heard by another person. When the speech splitter 154 is executed in an app state/step of the system 100, the speech splitter 154 separates the user's audible speech into small audio segments of only a few words each, and transmits only a subset of those segments (namely, the audio snippets 153) to the user video conference application 130. In one example, for a speech passage that includes the sentence “I was pleasantly surprised by the warmth of the water in the lake, because there was still snow on the ground,” the speech splitter 154 might only create and transmit the following audio snippet(s) 153: “. . . surprised by the warmth ... because there was”.

This use of audio snippets 153 reduces the linguistic/stuttering stress experienced by the user that might otherwise occur if his or her full audio were transmitted. If the speech splitter 154 is executed, then in addition, full text of the user's spoken audio (as transcribed by the STT module 124) is also transmitted to the user video conference application 130 to maintain the flow of conversation with the RCP 148 at the remote computer system 30.

The problematic word generator 188 can access problem words previously identified by the user 10, via the GUI 90 as previously disclosed in the description of FIG. 1A hereinabove. Based on the user-identified problem words 77, the problematic word generator 188 might generate additional candidate problem words having the same starting letters or similar sounds. If the user verifies these additional candidate problem words as being fluency-challenging, the problematic word generator 188 can then update the stored set of problem words 77 at the data repository 70 with the generated words.

During operation of the speech therapy system 100, the fluency self-reporting module 119 might be configured for use in the first app state/step (and possibly in all other app states/steps as well) to determine user fluency. For this purpose, in one implementation, the module 119 receives a user self-report of fluency, provided as input from the user 10 via the GUI 90. For this purpose, in one example, the GUI 90 might present a number of fluency options for the user 10 to select (e.g., low fluency, average fluency, full fluency), and the user 10 selects one of the options as the self-report of fluency. The app 114 then forwards the self-report of fluency, based on words spoken by the user during the current GSE, to the fluency self-reporting module 119. Additionally and/or alternatively, the fluency self-reporting module 119 might perform all of the actions just described. The module 119 then transmits the self-reported fluency to the promotion manager 138, which determines whether the reported fluency meets an upper fluency threshold of the current GSE.

The fluency monitor 118 might be configured for use in GSE A-6/app state 6/system step 6 (and possibly in all subsequent app states/steps) to compute a fluency score that is based on processing the user speech. In more detail, the fluency monitor 118 receives an audio representation of user speech from the MIC 106 as input, computes a percentage of stuttered syllables, and passes this data as input to the promotion manager 138. In this way, the promotion manager 138 can determine whether the user speech meets the upper fluency threshold 224 of the current GSE, based upon the audio signal representation of the user speech as received by the fluency monitor 118.

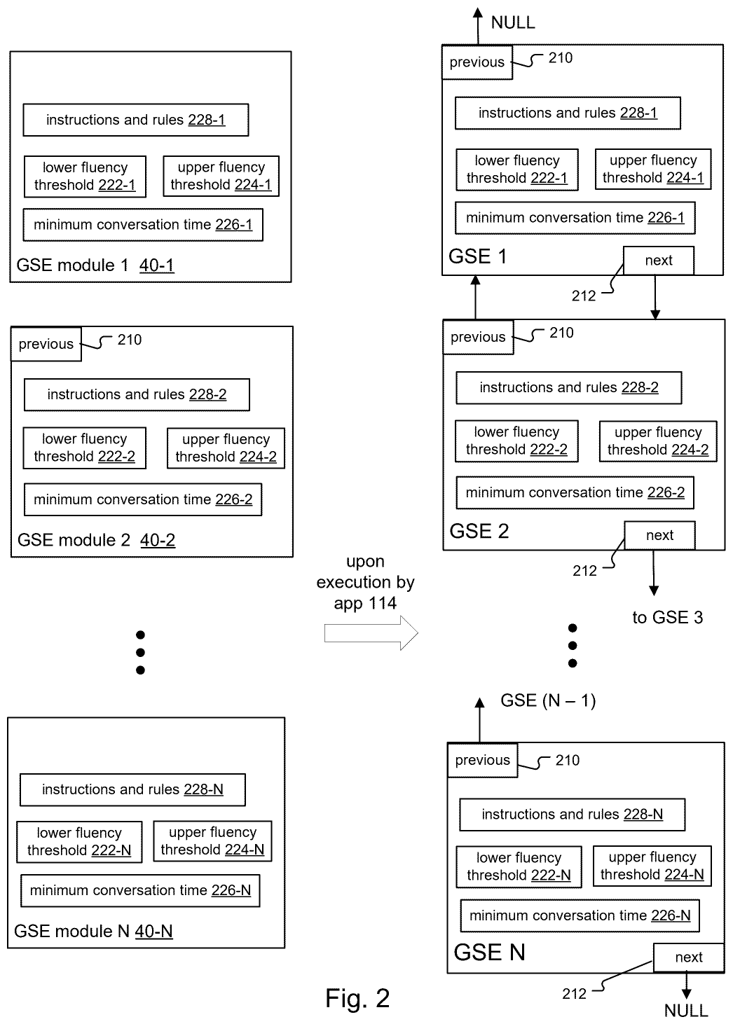

FIG. 2, on the left, shows a sequence of graduated speaking exercise (“GSE”) modules 40-1 . . . 40-N in the speech therapy system 100 of FIGS. 1A and 1B. Upon execution of each GSE module 40 by the app 114, the app 114 creates a separate GSE on the right that defines an associated state of the app 114/step of the system 100. After the app 114 executes each GSE module 40, the associated GSE and app state that result are managed and controlled by the app 114.

Each GSE module 40 includes a previous GSE module pointer or reference, indicated as “previous” pointer 210, a next GSE module pointer or reference, indicated as “next” pointer 212, instructions and rules 228, an upper fluency threshold 224, a lower fluency threshold 222 and a minimum conversation time 226.

The GSE modules 40-1 . . . 40-N, and the GSEs 1 . . . GSE N created by the GSE modules, are arranged in a sequence. In the first GSE 1, which begins the sequence, the previous pointer 210 points to NULL (no prior GSE) and the next pointer 212 points to GSE 2 as the next GSE. The GSE 2 previous pointer 210 points to prior GSE 1, and its next pointer 212 points to GSE 3 as the next GSE. This pattern repeats for each of the remaining GSEs in the sequence until the last GSE N. In the last GSE N, which ends the sequence, the previous pointer 210 points to GSE (N−1) and the next pointer 212 points to NULL (no next GSE) as the next GSE 40.

After initialization of the speech therapy system 100, the app 114 loads the sequence of GSE modules into the memory 12 and executes the instructions and rules 228 of the first GSE module 40-1. This creates a first GSE, or GSE 1, which defines a first state of the app 114/a first step of the system 100. In this first app state, once the promotion manager 138 is notified by the user 10 that the user 10 has achieved fluency in the first app state, the instructions and rules 228 of GSE 1 instruct the app 114 to execute the instructions and rules 228 of the next GSE, indicated by the next pointer 212 of GSE 1. Because the next pointer 212 of GSE 1 points to GSE 2, the app 114 executes the instructions and rules 228 of GSE 2. In response, the system 100 transitions to the next step/the app 114 transitions to the next app state, which is the second app state, defined by GSE 2.

Once the promotion manager 138 determines that the user 10 has achieved fluency in each step or app state (or is otherwise notified by the user 10 as achieving fluency), the app 114 transitions to each next app state indicated by the next pointer 212 of each current app state current GSE. Finally, when the system 100 is in the final app state/step N, once the promotion manager 138 is notified by the user 10 or determines that the user 10 has achieved fluency, the speech therapy system 100 can conclude that the user 10 is fluent. The system 100 can then notify the user 10 that they are fluent, such as by presenting a message to the GUI 90, presenting a voice message to the speakers 110, rendering a color associated with fluency (e.g., green) and presenting it to the GUI 90, sending an email to the user 10, sending a Short Message Service (SMS) message to a mobile phone user device carried by the user 10, or a combination of any of these notification means, or the like. This typically ends the speech therapy provided by the system 100.

FIG. 3 shows table 302. The table 302 includes a list of 31 GSEs and a brief description of each, for a speech therapy system such as any of the speech therapy systems disclosed herein. As the GSE number increases, so does the level of conversational realism that the GSE provides. In more detail, the table 302 is broken into four groups, or Campaigns, labeled A, B C and D. With each increasing GSE number in each Campaign, and with each successive Campaign, each GSE provides an increasing level of conversational realism.

Campaign A includes GSEs A-1 to A-13, all of which are configured such that the user 10 has no communication with other humans/RCPs 148. The app 114 will instruct users, through the GUI 90, to ensure that they are completely alone when participating in all GSEs in Campaign A and that their speech cannot be heard by other people, for example through open windows, cracked doors, or thin walls. A summary of the GSEs in Campaign A are included below.

The first four GSEs A-1 through A-4 generally operate as follows. GSE A-1 starts with the user 10 reciting sanitized text passages 34 in unison with the choral reader 190. In GSE A-2, the user 10 recites an unsanitized text passage in unison with the choral reader 190. At GSE A-3, the user 10 recites a sanitized text passage 34 and the choral reader 190 is disabled. In GSE A-4, the user recites an unsanitized text passage and the choral reader 190 is disabled.

In GSEs A-5 through A-13, the user 10 remains in a “speaking while alone” environment, but for the first time, software components are used to process the user's speech in a variety of ways. A user's knowledge that his or her speech is being processed electronically introduces a ‘presence’ of a listener into the user's conversational environment (albeit only a software listener, not a person), which represents a small incremental step toward a more realistic conversational environment. For example, in GSE A-5, the STT module 120 transcribes the user's speech into text, and the text is displayed on the video monitor 108. Further, in GSE A-6, the user's speech is processed by the fluency monitor 118, which applies algorithms to the user's speech to compute a fluency metric, or score, that rates the user's fluency. Then, in GSE A-7, in another example, the user recites a sanitized text passage 34 to the artificial intelligence chatbot conversational partner (e.g., chatGPT module 122), which appears to understand the user speech because it generates text-based responses that are pertinent to what the user has just said.

By the time GSE A-9 is reached, the user 10 is engaged in audio-based conversation with the chatGPT module 122. Here, the user 10 speaks, and the chatGPT module 122 responds audibly. GSEs A-10 and A-11 introduce video avatars that provide visages for the chatGPT module 122 and the user. The avatar's facial expressions and lip movements are typically generated to be consistent with their audio signals. At GSE A-12, in another example, the app 114 presents the user 10 with an unsanitized text passage to recite, and the virtual reality driver 128 can present a virtual audience of passive (silent) listeners for display at the VR headset 112. Finally, in the last GSE of campaign A, GSE A-13, the user 10 converses with an ‘active’ virtual audience that is generated by the virtual reality driver 128 and is displayed on the VR headset 112. In this context, an ‘active’ audience is one which is driven by a Virtual Reality generator, such as Ovation VR. Ovation VR has TTS/STT capabilities and can create audible conversational responses to the user's speech. These audible conversational responses are ‘spoken’ by various of the VR audience members, in the sense that the facial expressions and lip movements of the responding VR audience member is consistent with the audible response itself.

Campaign B includes GSEs B-1 to B-9, all of which establish video conference calls/sessions between the user 10 and an RCP 148. With the exception of GSEs B-8 and B-9, these GSEs are configured such that only a text representation of the user's speech is transmitted to the RCPs 148 in the video conference calls. In all of the GSEs in Campaign B, the STT module 120 transcribes the user's speech into text. In one example, in GSE B-1, the user recites a sanitized text passage 34 in unison with the choral reader 190 as in GSE A-1. In addition, the STT module 120 transcribes the user's recited speech into text. The transcribed text (but not the user's audible speech) is then forwarded to a remote video conference application 146 executing on the remote computer system 30. In this way, GSE B-1 enables two-way, text-only communications between the user 10 and an RCP 148 at the remote computer system 30.

More detail for other GSEs in Campaign B are as follows. GSE B-5 transcribes a user's conversational speech (rather than just a recitation of a prepared text) via the STT module 120 into text, and the text is forwarded to the RCP 148 at the remote computer system 30. The RCP 148 then replies with text-based responses that are displayed on the user's monitor 108. GSE B-9, in another example, further reconstructs the transcripted text of user speech back into a synthetic speech audio signal using the TTS module 124. GSE B-9 then transmits the synthetic speech audio signal to one or more RCPs 148. As a result, GSE B-9 establishes two-way audio and video conversations between the user 10 and one or more RCPs 148, during which the user 10 original speech is not heard by any RCPs 148.

Campaign C includes GSEs C-1 to C-8. Like the GSEs of Campaign B, these GSEs establish video conference calls between the user 10 and one or more RCPs 148. However, these GSEs are configured such that, for the first time in the program, an audio representation of the user's speech is transmitted in some form to the RCPs 148. At GSE C-1, for example, the user recites a sanitized text passage in unison with the choral reader 190, and the app 114 sends an audio representation of the user speech to an RCP 148. In the first six GSEs of Campaign C, the transmission of user video to the RCP 148, and the display of received RCP video on the user's monitor, is enabled or disabled at the discretion of the user. As in Campaigns A and B, the first four GSEs in Campaign C utilize various combinations of user recitation of sanitized or unsanitized text passages, either in unison with the choral reader 190 or without use of the choral reader 190.

In GSE C-5, the user converses freely with an RCP 148 in a video conference call, rather than reciting from a prepared text, but only occasional ‘snippets’ of the user speech are transmitted rather than full audio. For example, the speech splitter 154 may release only 2-3 seconds of user audio every 10 seconds, and only the released audio signal is sent to the audio-input terminal of the user video conference application 130. The audio signal is then transmitted to RCP 148 on the remote computer system 30. To maintain continuity of the conversation, in addition to transmitting the audio snippets of user speech, the user speech is also transcribed into text by the STT module 124, and the full transcription is transmitted to the RCP 148.

At GSE C-6, the user speech is not transmitted to the RCP 148 in real time; rather, the user speech is recorded by the speech recorder 152, ideally in relatively short portions of one or two sentences. The speech recorder module 152 then transmits the portions of recorded speech to the user video conference application 130, conditioned upon approval of the user 10. Typically, the user 10 would approve the transmission if the user is satisfied with the fluency of his or her recorded speech. In this way, the user 10 is assured that the RCP 148 does not receive disfluent user speech/does not hear the user speak disfluently. The recorded speech is deleted if the user does not grant approval, and it is also deleted after the user 10 grants approval and the recorded speech is transmitted to the user video conference application 130. As in GSE C-5, to maintain continuity of the conversation, the user speech is also transcribed into text by the STT module 120, and the transcripted text is transmitted to the RCP 148.

Preferably, the system 100 does not make a permanent recording of user speech, because that would violate the “speaking while alone” premise that is known to promote fluency and to reduce anxiety about speaking fluently.

GSE C-7, which is nearing the end of the fluency program (it is the 28th GSE in the system 100), is the first instance where the user 10 engages in real-time speech with an RCP 148, without any need for the user 10 to pre-approve the user speech or with any fluency assistance in the form of reciting a sanitized text passage or reciting text in unison with a choral reader. Note that the conversational environment in GSE C-7 is equivalent to a standard video-conference call/session: the user transmits real-time audio and video signals to the RCP 148, and in return receives real-time audio and video signals from the RCP 148.

The conversational environment in GSE C-7 is comparable to an in-person conversation with another person. Therefore, if the user maintains strong fluency throughout GSE C-7 and also anticipates fluent speech in GSE C-7, there is reason to expect that the user will likely experience fluency during subsequent in-person conversations outside of the system 100.

GSE C-8 extends the realism of the conversational environment still further, by allowing the user 10 to engage in free-form audio conversations with multiple RCPs where the conversations also include video of the user 10 and video of each of the RCPs.

Campaign D includes only a single GSE, D-1, and it is optional. In GSE D-1, the user 10 recites a sanitized text passage in unison with the choral reader 190 to an in-person conversational partner. This GSE is optional because it may be unnecessary; if users 10 both experience and anticipate fluency in GSE C-8, when they are in real-time, full-audio and full-video conversation with multiple RCPs in a video conference call, then there is reason to expect that they will continue to experience fluency during in-person conversations without the aid of reciting sanitized speech or reciting in unison with the choral reader 190.

While the table 302 shows 31 GSEs, it can also be appreciated that any number of GSEs (and their contents) can be configured for use in the speech therapy system 100. For this purpose, in one example, a clinician can populate the data repository 70 with a different number of GSE module files 116, and/or different contents of the files 116, as part of a software upgrade to the system 100. Once the system 100 is restarted, the computer system 20 loads the updated GSE module files 116, creates corresponding GSE modules 40 from the module files 116, and the app 114 creates a GSE for each GSE module 40, as previously disclosed in the description of FIGS. 1A and 1B included hereinabove.

FIG. 4 provides more detail for the configuration of hardware and software components in each of the 31 GSEs described in FIG. 3. The GSEs are listed top-down and numbered from GSE A-1 to GSE D-1 in order of least to greatest conversational realism.

In FIG. 4, table 400 shows more detail for the configuration of the hardware peripherals 50 and the modules 11 in the Campaign A, B, C and D GSEs. Here, GSEs A-1 to A-13 of Campaign A, GSEs B-1 to B-9 of Campaign B, GSEs C-1 to C-8 of Campaign C, and GSE D-1 of Campaign D are listed in rows. The corresponding configuration settings of the hardware peripherals 50 and modules 11 in each of the GSEs are listed in columns of the table 400. Legend 402 provides more detail for the values presented in the table 400. In the table 400, “O”indicates that the component is optional.

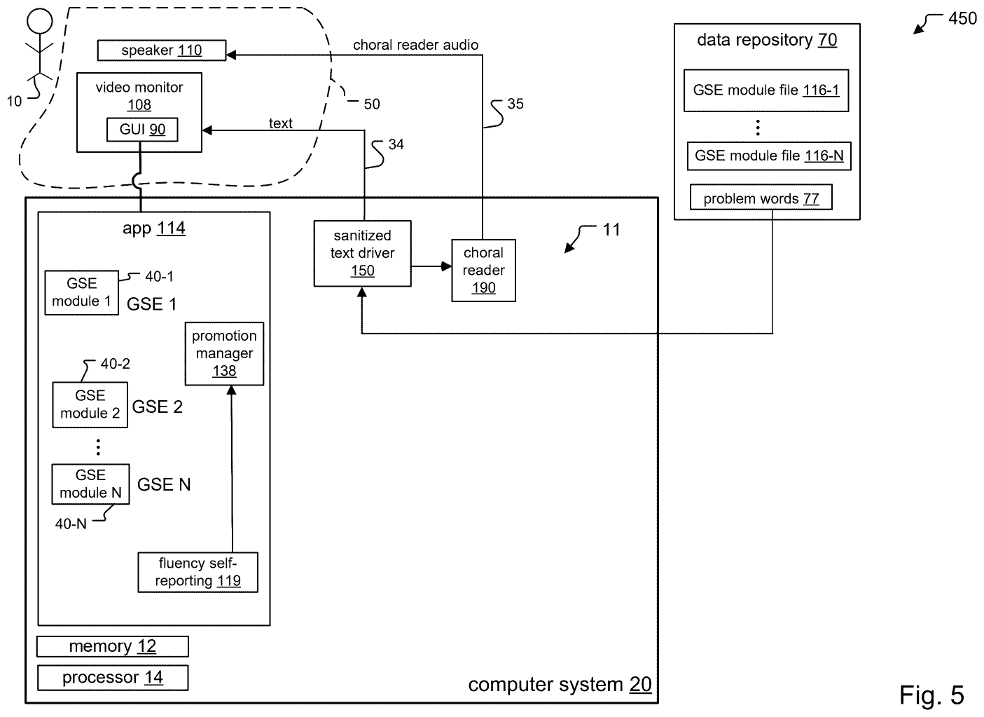

FIG. 5 shows a speech therapy system 450, according to an embodiment. The system 450 shows software modules 11 which are enabled during the first GSE of the system, GSE 1/A-1 (hereinafter GSE A-1). In the figure, only GSE A-1, the promotion manager 138, the sanitized text driver 150, the choral reader 190, the fluency self-reporting module 119, the video monitor 108, the GUI 90, and the speaker 110 are enabled.

GSE A-1 and its components are configured as follows. The instructions and rules of GSE A-1 specify that only the app 114, the sanitized text driver 150, the choral reader 190, the promotion manager 138 and the fluency self-reporting module 119 load and execute; none of the other modules 11 or the user video conference application 130 are loaded and executed. The MIC 106 and video camera 104 are turned off, and there is no audio or video output transmitted from an RCP 148. Moreover, the promotion manager 138 is configured to only accept input from the user 10 regarding the fluency of the user 10, as reported through the fluency self-reporting module 119.

GSE A-1 generally operates as follows. The sanitized text driver 150 generates a sanitized text passage 34 on a topic of interest to the user, which text avoids the use of any of the problematic words 77. The sanitized text driver 150 transmits the sanitized text 34 to the GUI 90 and also transmits the sanitized text passage 34 as input to the choral reader 190. The user 10 then recites the sanitized text passage 34 aloud, in the absence of any listeners. At the same time, the choral reader 190 generates a choral reader audio signal 35 that comprises a synthetic speech rendition of the text passage, and the audio signal 35 is presented to the user's audio output device (e.g., computer speakers 110 or a headset). As a result, the user 10 recites the sanitized text passage 34 in unison with the choral reader 190. Note that the MIC 106 can be turned off, because neither the user 10 nor any software components listen to the user speech.

It is essential to the effectiveness of the speech therapy system 100 that in this first step, users 10 completely believe that they are “speaking while alone.” Otherwise, research has shown that the user will not experience the fluent speech that is expected when speaking alone. See Jackson 2021. Because GSE A-1 assumes that the user's speech is heard by no other individual, nor by a software component, only the user 10 can make the decision as to whether the user 10 has achieved fluency for the recited text, and is therefore ready to move to the next app state/next GSE of increased conversational stress or realism.

At the same time, the user 10 may receive some guidance from the app 114 or promotion manager 138. In examples, the guidance might include prewritten suggestions via the GUI 90 (e.g. “continue in this step until you fully expect to experience fluent speech, then continue for one more hour, then move on to the next step”) or text-based questions and answers. For example, because the data for GSE A-1 includes a minimum conversation time, the app 114 could display the remaining time on the GUI 90 (e.g., “minimum time left: 37 minutes”). Once the minimum time is exceeded, several buttons could appear on the GUI 90, e.g., “continue for 30 minutes”, “continue for 60 minutes”, or “promote me to the next GSE module”. If the user 10 selects the latter, then the GUI 90 might pose a series of questions through the fluency self-reporting module 119 with radio-button responses, e.g., “Rate your fluency over the past 60 minutes: (a) entirely fluent; (b) very fluent; (c) mostly fluent; (d) a little disfluent; (e) quite disfluent.”

Based on the total time duration that the user has spent thus far in GSE A-1, if the user 10 continues to report considerable disfluency, the app 114 may suggest to the user 10 that this fluency therapy is unlikely to be effective at this time. Otherwise, if the user self-reports options (a) or (b), for entirely fluent or very fluent, respectively, and has met the minimum conversation time, the promotion manager 138 then recommends that the user be “promoted”to the next app state/next step, defined by the next GSE of the current GSE. Here, the next GSE is GSE A-2.

After one or more speaking exercises in this GSE, where each speaking exercise requires that the user 10 recite a sanitized text passage, the user 10 will invoke the promotion manager module 138 to decide whether to proceed on to the next GSE, GSE A-2, or else remain in the current GSE for additional practice. Note that in this GSE, the promotion manager 138 will be informed only by a length of time that the user 10 has spent performing speaking exercises in this GSE, and by a self-report of fluency from the user 10, via the fluency self-reporting module 119. This is because in this GSE, the fluency monitor 118, which rates the fluency of the user's speech, is turned off. The self-report of fluency includes information concerning the user's perceived fluency and optionally anticipation of fluency during the speaking exercises.

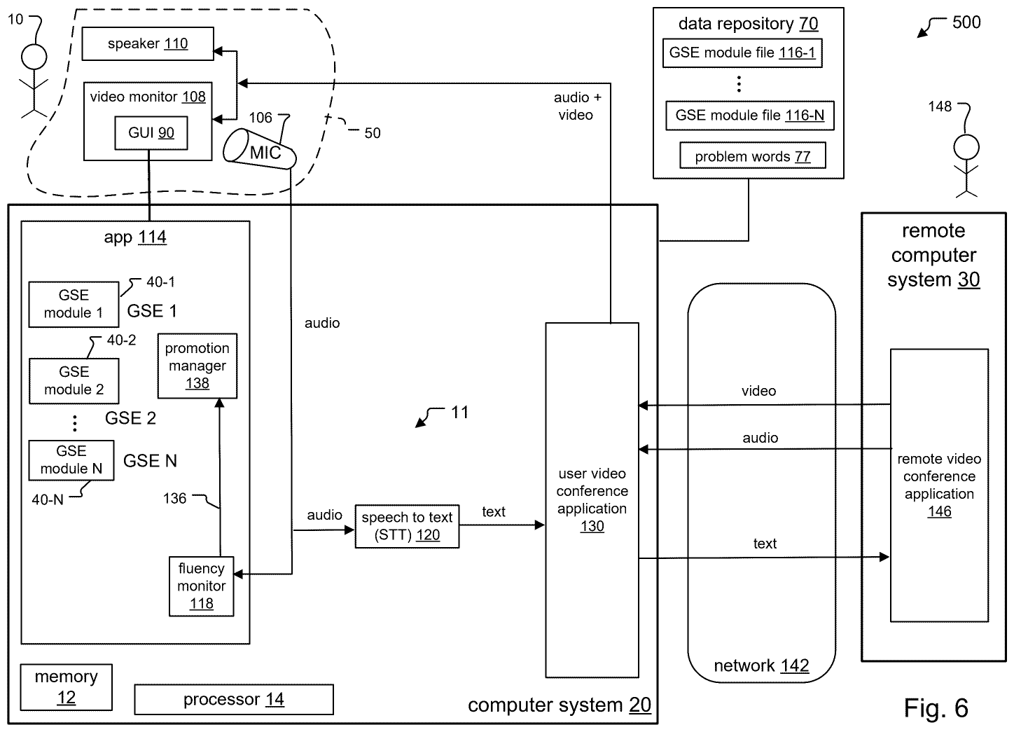

FIG. 6 shows another speech therapy system 500, according to an embodiment. The system 500 implements GSE B-6 of Campaign B. GSE B-6 includes substantially the same components and operates in substantially the same way as in the system 100 of FIGS. 1A and 1B, but there are fewer hardware peripherals 50 activated and fewer modules 11 either activated or enabled.

In the illustrated example, the hardware peripherals 50 include the video monitor 108, the speaker 110 and the MIC 106. Of the modules 11, only the GSE modules 40, fluency monitor 118, promotion manager 138, STT module 120 and user video conference application 130 are either enabled or shown. The use of the fluency self-reporting module 119 in this GSE is optional and is not shown.

In the speech therapy system 500, the STT module 120 receives an audio representation of user speech from the MIC 106 and converts the audio to text. As a result, only text is transmitted from the user 10 to any RCPs 148. In GSE B-6, the RCP 148 is represented audibly and visually to the user through the user 10's video monitor 108 and speakers 110, using signals that are received by the user video conference application 130.

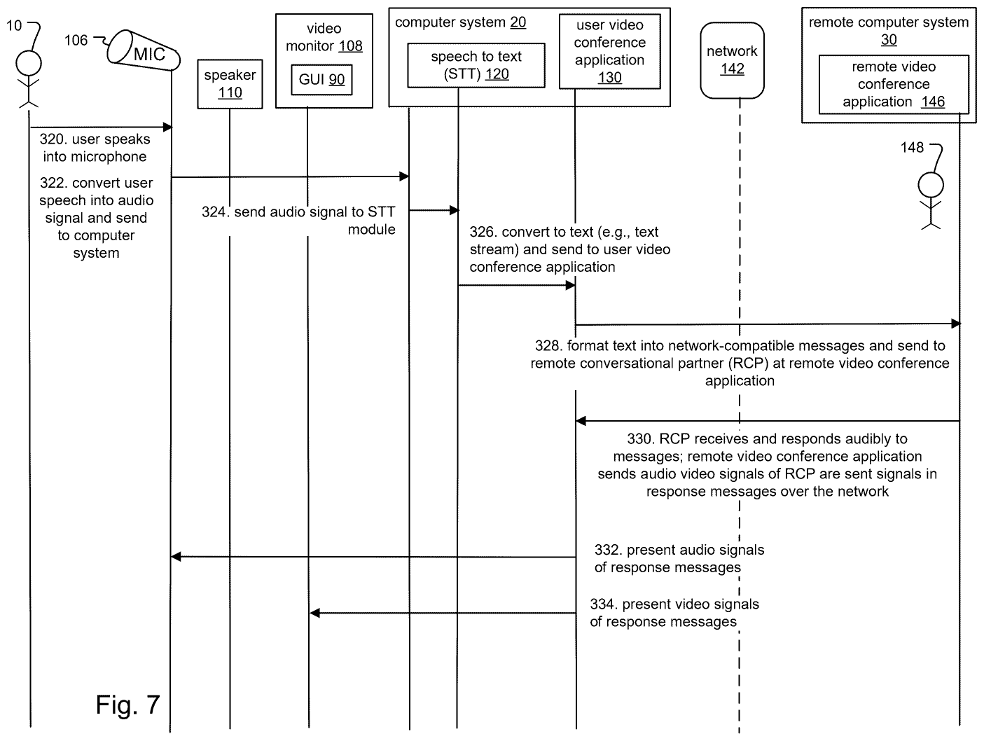

FIG. 7 illustrates a method of operation of the app state/system step shown in the speech therapy system 500 of FIG. 6. The method begins in step 320.

In step 320, the user 10 speaks into the MIC 106, which converts the user speech into an audio signal representation in step 322. The audio signal representation of the user speech is then sent to the computer system 20. In step 324, the computer system 20 sends the audio signals to the STT module 120. According to step 326, the STT module 120 converts the audio signals to text (e.g., a text stream) and sends the text stream to the user video conference application 130. In step 328, the user video conference application 130 formats the text into network-compatible messages, and sends the packets over the network 142 to the remote video conference application 146 on the remote computer system 30, for consumption by an RCP 148 at the remote computer system 30.

According to step 330, the RCP 148 responds audibly to the messages, and the remote video conference application 146 sends audio signals and video signals of the RCP 148 in response messages to the user video conference application 130 via the network 142. The user video conference application 130 then presents the audio signals at the speaker 110 in step 332, and presents the video signals to the video monitor 108 and/or GUI 90 in step 334.

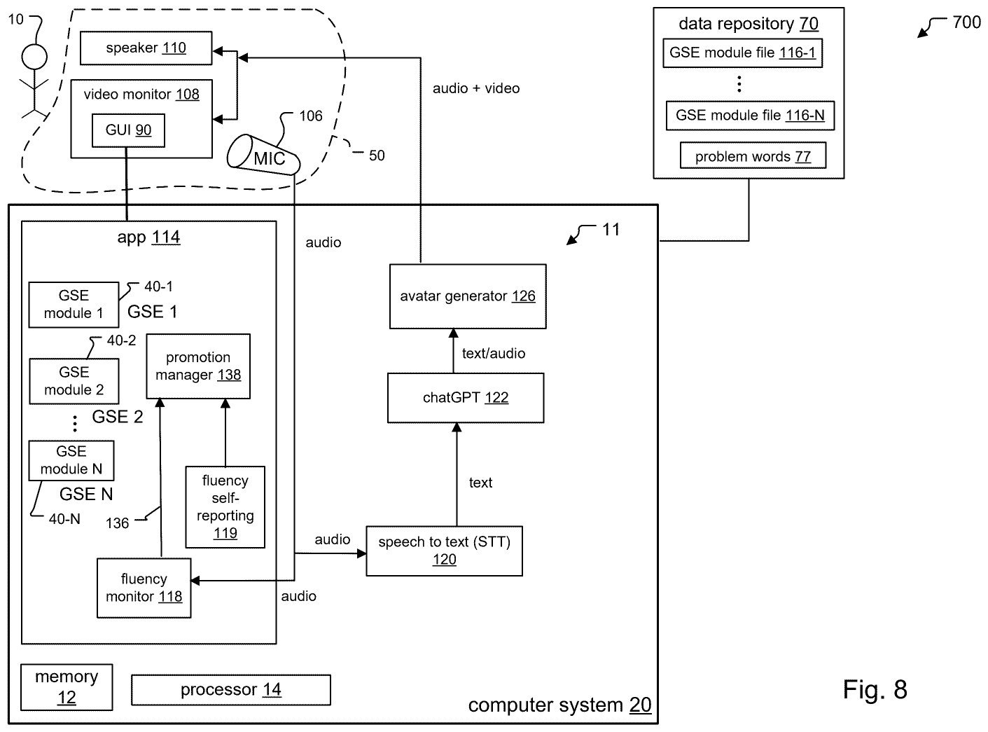

FIG. 8 shows another speech therapy system 700, according to an embodiment. The system 700 implements GSE A-10 of Campaign A. GSE A-10 includes substantially the same components and operates in substantially the same way as in the system 100 of FIGS. 1A and 1B, but there are fewer hardware peripherals 50 activated and fewer modules 11 either activated or enabled.

In the illustrated example, the hardware peripherals 50 include the speaker 110, the video monitor 108 and the MIC 106. Of the modules 11, only the GSE modules 40, the fluency monitor 118, the fluency self-reporting module 119, the STT module 120, promotion manager 138, chatGPT module 122 and the avatar generator 126 are either enabled or shown. The fluency monitor 118 is turned on at the option of the user.

In the speech therapy system 700, GSE A-10 defines an app state/step of the system 700 such that the chatGPT module 122 receives a text transcription of user speech from the STT module 120, which in turn receives its audio signal from the MIC 106. Note that in some implementations, the chatGPT module 122 can receive an audio signal directly from the MIC 106, without the need to have it transcribed into text by the STT module 120. The chatGPT module 122 formulates a conversational response in either text or audio format. These conversational responses are then transmitted as input to the avatar generator 126. The avatar generator 126, in turn, generates an animated video, or avatar, of an individual's head with lip and face movements. If text is received by the avatar generator 126, then the avatar generator 126 will be responsible for converting the text into spoken words. The video and audio outputs of the avatar are communicated to the user 10 by the video monitor 108 and the speaker 110. Because the user video conference application 130 is not enabled, the remote computer system 30, its remote video conference application 146, and RCPs 148 are also not shown.

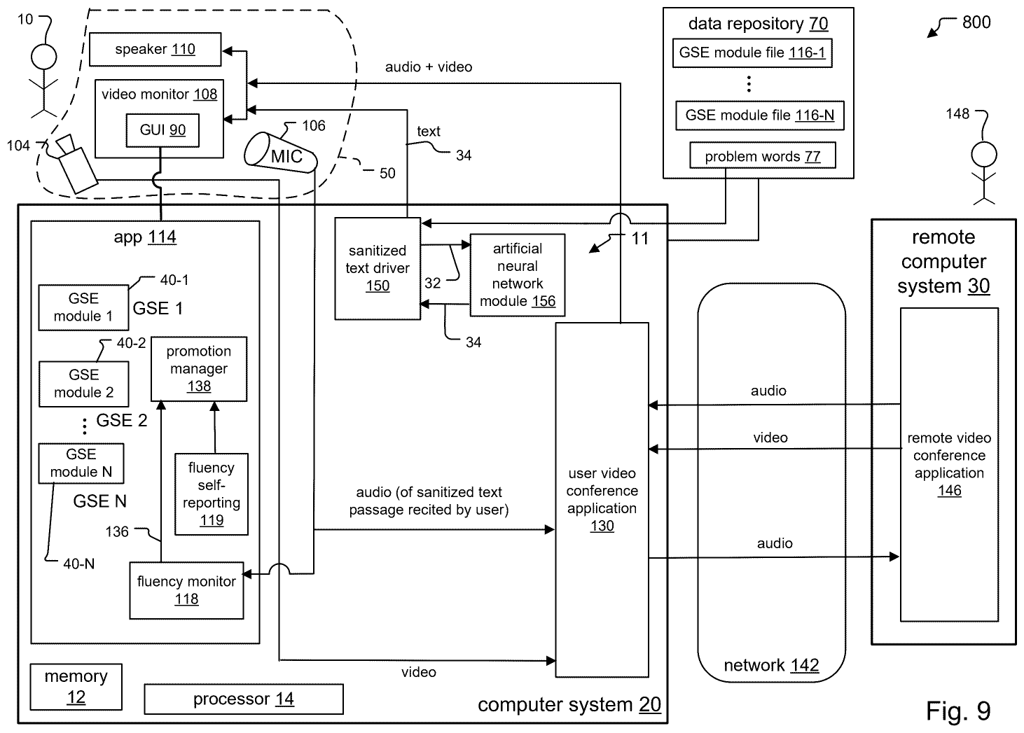

FIG. 9 shows yet another speech therapy system 800, according to an embodiment. The system 800 implements GSE C-3 of Campaign C. GSE C-3 includes substantially the same components and operates in substantially the same way as in the system 100 of FIGS. 1A and 1B, but there are fewer hardware peripherals 50 activated and fewer modules 11 either activated or enabled. In the illustrated example, the hardware peripherals 50 include the speaker 110, the video monitor 108, the MIC 106 and the video camera 104. Of the modules 11, only the GSE modules 40, fluency monitor 118, fluency self-reporting module 119, promotion manager 138, sanitized text driver 150, artificial neural network module 156 and the user video conference application 130 are either enabled or shown.

GSE C-3 defines an app state/step of the system 800 such that the sanitized text driver 150 presents a sanitized text passage 34 to the GUI 90 for the user 10 to recite. The sanitized text passage 34 is preferably constructed to include a limited number of problem words 77, such as 10 or fewer problem words 77, or possibly none of the problem words 77. The user 10 receives the sanitized text passage 34 at the GUI 90, recites the sanitized text passage, and the MIC 106 converts the user speech into an audio signal representation. The audio signals are then forwarded to an RCP 148 via the user video conference application 130, the network 142 and the remote video conference application 146.

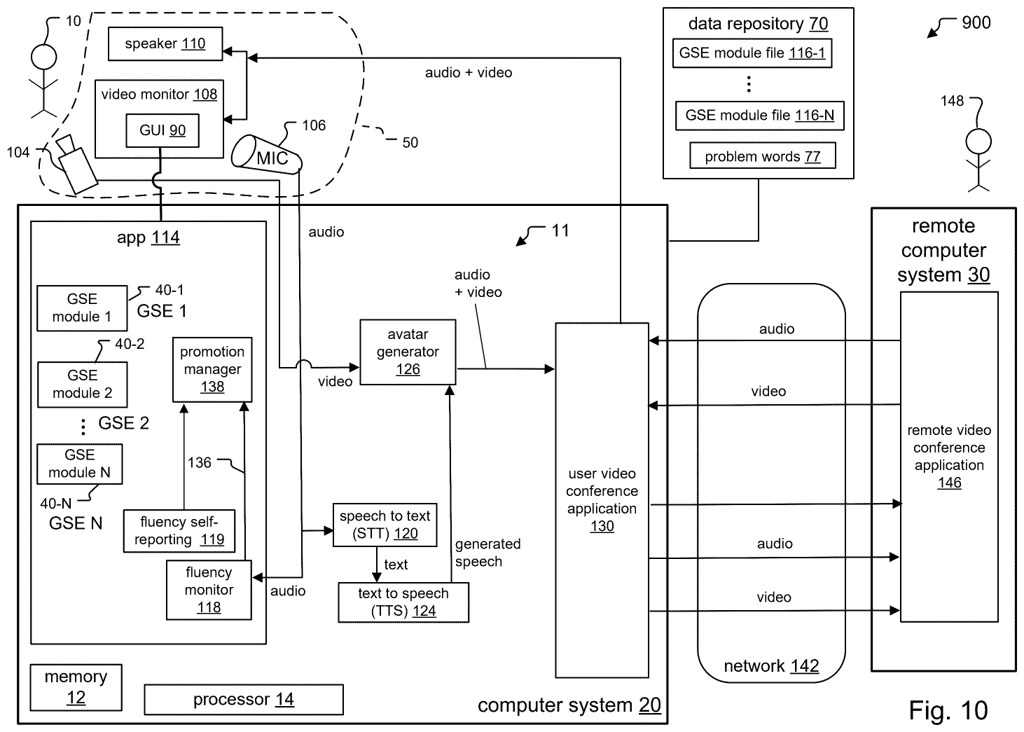

FIG. 10 shows still another speech therapy system 900, according to still another embodiment. The system 900 implements GSE B-8 of Campaign B. GSE B-8 includes substantially the same components and operates in substantially the same way as in the speech therapy system 100 of FIGS. 1A and 1B, but there are fewer hardware peripherals 50 activated and fewer modules 11 either activated or enabled. In the illustrated example, the hardware peripherals 50 include the speaker 110, the video monitor 108, the MIC 106 and the video camera 104. Of the modules 11, only the GSE modules 40, fluency monitor 118, fluency self-reporting module 119, promotion manager 138, avatar generator 126, STT module 120, TTS module 124 and the user video conference application 130 are either enabled or shown.

GSE B-8 defines an app state/step of the system 900 such that the user 10 is fully ‘represented’ by an avatar with regard to both video and audio signals. The user's speech is transcribed into text by the STT module 120 and then that text is converted back into synthetic speech via the TTS module 124. An animated avatar of the user's head is generated by the avatar generator 126. Detailed lip and facial expressions of the avatar are informed by the actual lip and facial expressions of the user, as captured in the image data by the video camera 104, and/or by the synthetic speech that is generated by the TTS module 124. The user 10 receives full, real-time audio and video signals from the RCP 148 at the video monitor 108 and speaker 110.

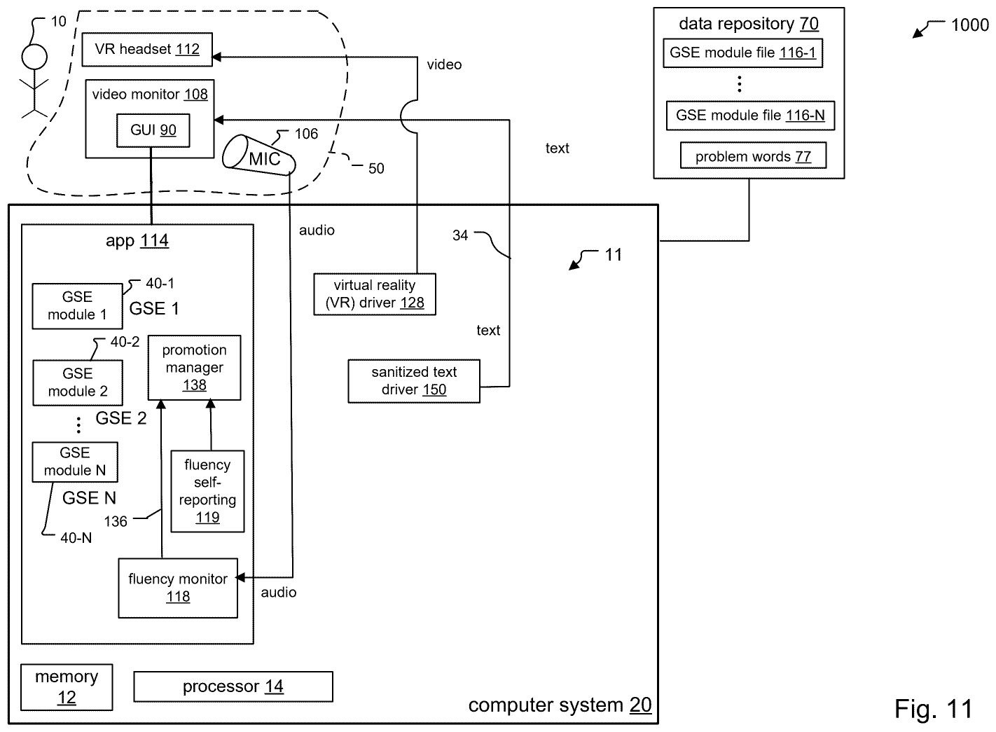

FIG. 11 shows yet another speech therapy system 1000, according to yet another embodiment. The system 1000 implements GSE A-12 of Campaign A. GSE A-12 includes substantially the same components and operates in substantially the same way as in the speech therapy system 100 of FIGS. 1A and 1B, but fewer hardware peripherals 50 and fewer modules 11 are included or enabled as compared to the speech therapy system 100.

In the illustrated example, the hardware peripherals 50 include the VR headset 112, the video monitor 108 and the MIC 106. Of the modules 11, only the GSE modules 40, fluency monitor 118, fluency self-reporting module 119, promotion manager 138, sanitized text driver 150, and the virtual reality driver 128 are either enabled or shown. As in the speech therapy system 500 of FIG. 5, the user video conference application 130 is not enabled and thus not shown. As a result, the remote computer system 30, its remote video conference application 146, and RCPs 148 are also not included and not shown.

GSE A-12 defines an app state/step of the system 1000 such that the user 10 recites a text passage, while alone. In the example, an unsanitized text passage 34 is generated by the sanitized text driver 150 and is displayed to the user on the video monitor 108. In an alternate implementation, a sanitized text passage could be generated by the sanitized text driver 150, since the sanitized text driver 150 is capable of generating both sanitized and unsanitized text passages. In still another implementation, the text passage could be any preprinted text material, such as a book, magazine, or a web site. At the same time, the user 10 is wearing the VR headset 112, which displays a virtual, silent listening audience of one or more people as generated by the virtual reality driver 128.

The critical element in the app state/step of the system 1000 defined by GSE A-12 is that the user is ‘immersed’ in a VR audience while still knowing that the user 10 is actually “speaking while alone”. In the app state defined by GSE A-12, the VR audience generated by the virtual reality driver 128 is initially small, typically including as few as one virtual individual but no more than three virtual individuals. The characteristics of the virtual audience in the GSE A-12 speaking exercises, such as the number of audience members, their age, sex, social status, as well as the speaking venue, are progressively changed by the VR driver 128 to migrate from a lower fluency anxiety-inducing state (e.g. small number of audience members, young, same sex as the user, low social status, in a home setting) to higher fluency-inducing states (e.g., many older people in business attire, in a large conference hall).

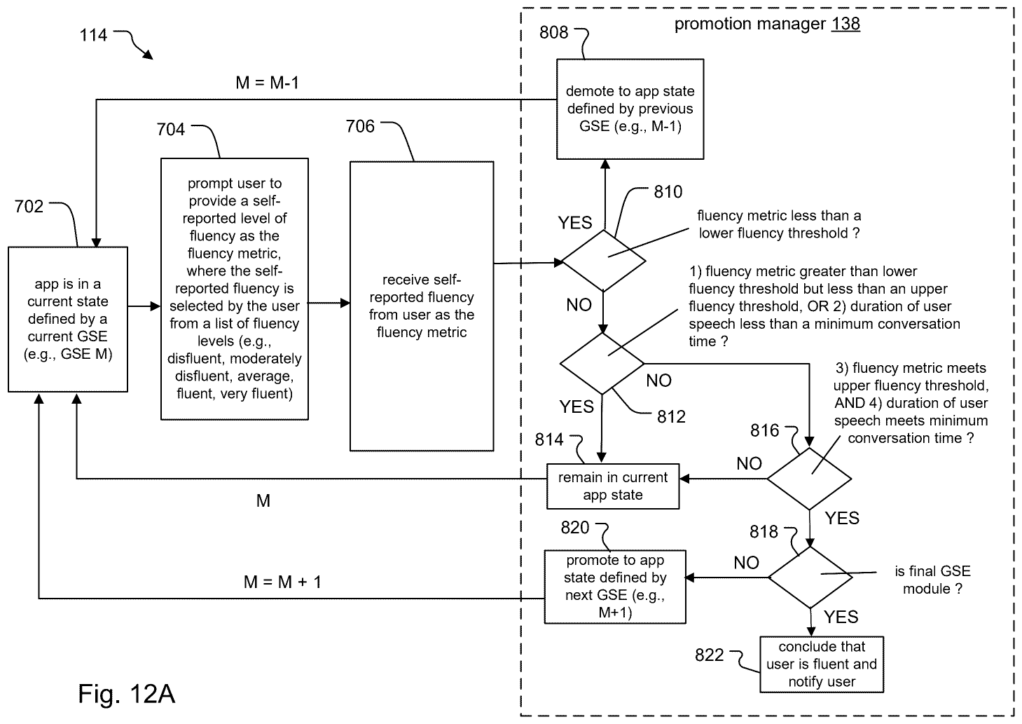

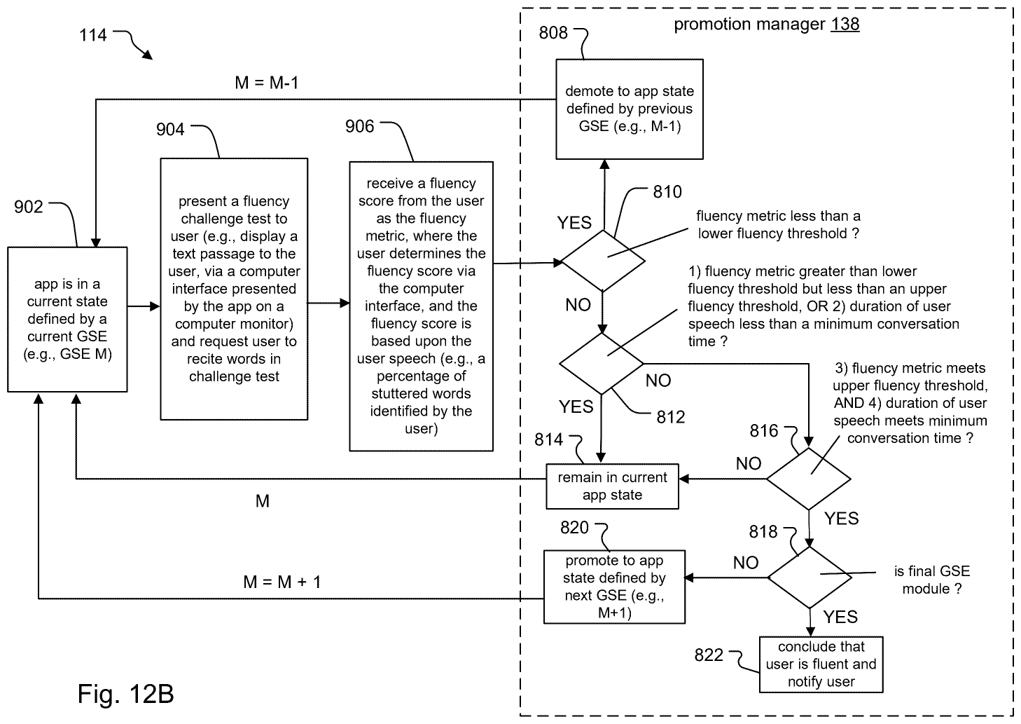

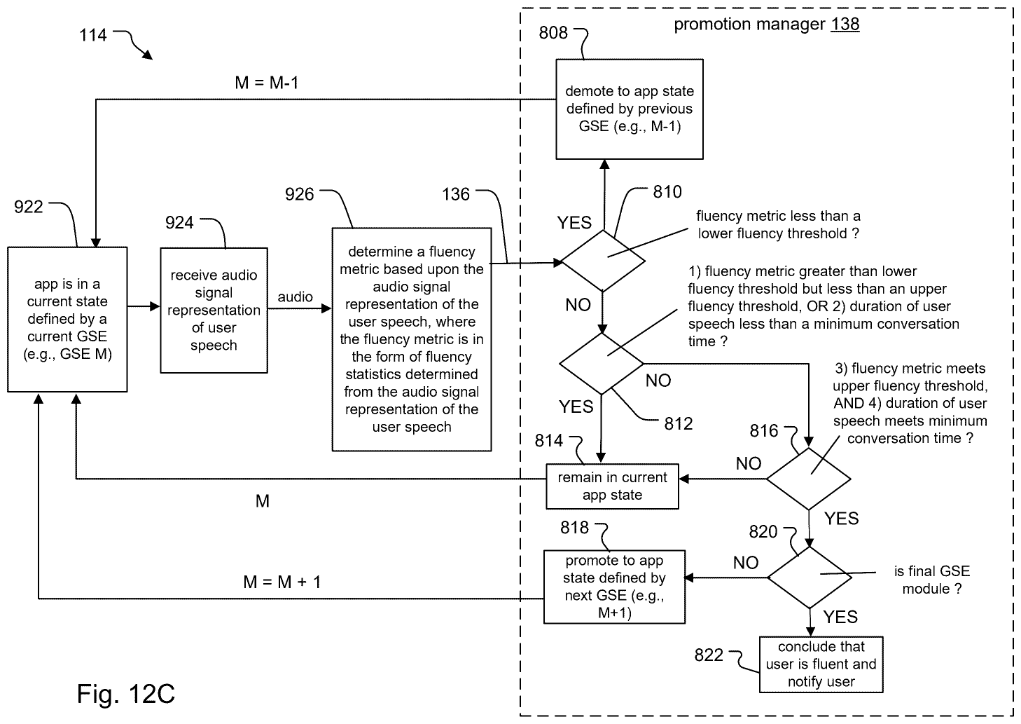

FIG. 12A shows a method of the app 114, namely, a method associated with operation and logic of its promotion manager 138. The app 114 obtains an indication of self-fluency from the user 10, and uses the received indication of self-fluency as a fluency metric. The promotion manager 138 then makes a promotion decision based upon the fluency metric. For this purpose, the promotion manager 138 determines whether to keep the app 114 in the current app state, promote the app 114 to the next app state, or demote the app 114 to a previous app state, based upon the fluency metric.

The promotion manager 138 can then either perform the promotion decision directly, or present the promotion decision as a recommendation to the user 10. In the latter case, the user 10 can then accept the recommended promotion decision or elect to pursue a different path forward (i.e. remain in current GSE or demote to a previous GSE). In the illustrated example, the promotion manager 138 in the method of FIG. 12A performs the promotion decision directly. The method begins in step 702.

In step 702, the app 114 is in a current state, labeled as state M, defined by a current GSE. In step 704, the app 114 prompts the user 10, such as via the GUI 90, to provide a self-reported level of fluency as a fluency metric. For this purpose, the fluency self-reporting module 119 presents a list of fluency levels to the user 10 via the GUI (e.g. disfluent, moderately fluent, average fluency, fluent or very fluent). The user 10 then selects one of the fluency levels, and the fluency self-reporting module 119 sends the user selection to the app 114.

According to step 706, the app 114 receives the self-reported fluency as the fluency metric. The method then transitions to step 810, where the app 114 sends the fluency metric to the promotion manager 138 for further processing.

In step 810, the promotion manager 138 determines whether the fluency metric is less than a lower fluency threshold 222 of the app state/step of the system/GSE that defines the app state. If the fluency metric is less than the lower fluency threshold 222, the method transitions to step 808; otherwise, the method transitions to step 812.

In step 808, the promotion manager 138 demotes the app 114 to the app state defined by the previous pointer 210 (namely, state M−1), and control passes back to step 702. In step 812, the promotion manager 138 decides whether the fluency metric is greater than the lower frequency threshold 222 but less than the upper fluency threshold 224 of the current app state, OR, whether the duration of user speech is less than the minimum conversation time 226 of the current app state. If either of these decisions resolves to TRUE, the method transitions to step 814; otherwise, the method transitions to step 816.

In step 814, the app 114 remains in the current app state M, and control passes back to step 702. In step 816, the promotion manager 138 decides whether the fluency metric at least meets the upper fluency threshold 224 of the current app state, AND, whether the duration of user speech is at least meets the minimum conversation time 226 of the current app state. If both of these decisions resolve to TRUE, the method transitions to step 818; otherwise, the method transitions to step 814 and the app 114 remains in the current app state.

According to step 818, the promotion manager 138 determines whether the current app state is the final app state, defined by a final GSE. If the current app state is the final one, the method transitions to step 822, and the app 114 concludes that the user 10 has achieved fluency, and can notify the user 10 in response. Otherwise, the method transitions to step 820.

In step 820, the promotion manager 138 promotes the app 114 to the app state defined by the next pointer 212 (namely, state M+1), and control passes back to step 702.

FIG. 12B shows another method of the app 114. The app 114, via its promotion manager 138, determines a fluency metric based upon an audio signal representation of the user's speech. The app 114 then determines whether to keep the app 114 in the current app state, promote the app 114 to the next app state, or demote the app 114 to a previous app state, based upon the fluency metric.

As in the method of FIG. 12A, the promotion manager 138 in FIG. 12B either performs the promotion decision directly, or presents the promotion decision as a recommendation to the user 10. In the illustrated example, the promotion manager 138 performs the promotion decision directly. The method begins in step 902.

In step 902, the app 114 is in a current state, labeled as state M, defined by a current GSE. In step 904, the app 114 present a fluency challenge test to the user (e.g., displays a text passage to the user, via a computer interface/GUI 90 presented by the app 114 on the video monitor 108) and requests the user 10 to recite the words in the challenge test.

According to step 906, the app 114 receives a fluency score from the user 10 as the fluency metric, where the user 10 determines the fluency score via the computer interface/GUI 90, and the fluency score is based upon the user speech (e.g., a percentage of stuttered words/problem words identified by the user 10 during the challenge test).

More detail for step 906 is as follows. In one implementation, the user 10 marks or otherwise identifies the problem words 77 in the text passage that they just recited, and selects a button in the GUI 90 to calculate the associated fluency metric. In response to the button selection, the app 114 computes either a percentage of stuttered syllables or a percentage of stuttered words associated with the recited text passage. The computed percentage of stuttered syllables/percentage of stuttered words is saved to a buffer as a fluency score. The app 114 then passes the fluency score to the fluency monitor 118 as input. The fluency monitor 118 performs a lookup of the fluency score in a fluency table that maps fluency scores (e.g., percentage values of stuttered syllables or words in a recited text passage) to fluency metrics, to obtain a corresponding fluency metric. For example, a fluency score of 2.2% percent stuttered syllables might correspond to a “reasonably fluent” text-based fluency metric, or a numerical value of 4 out of a possible 5 number-based fluency metric. In another example, a fluency score of 1.0% percent stuttered syllables, or less, might correspond to either a “fluent” text-based fluency metric or a numerical value of 5 out of a possible 5 number-based fluency metric. The method then transitions to step 810, where the app 114 sends the fluency metric to the promotion manager 138 for further processing.

Steps 808 through 822 of the promotion manager 138 are identical to steps 802 through 822 in the method of FIG. 12A. As a result, based on the fluency score, the promotion manager 138 decides whether to remain in the same app state (and then transition back to step 902), demote the app 114 to the previous app state (and then transition back to step 902), or whether to transition to the next app state. If the current app state is the final app state, the method transitions to step 822 and concludes that the user is fluent; otherwise, the method transitions to the next app state (and then transitions back to step 902).

FIG. 12C shows yet another method of the app 114. The app 114, via its promotion manager 138, determines a fluency metric based upon fluency statistics 136 obtained by the fluency monitor 118. For this purpose, the fluency monitor 118 computes the fluency statistics 136 using a mathematical algorithm. The fluency monitor 118 receives an audio representation of the user's speech as input, and applies the mathematical algorithm to the input to obtain the fluency metric as output. Example algorithms that detect stuttered syllables and words from audio files include atrous convolutional neural networks (see Abedal-karim Al-Banna, Eran Edirisinghe and Hui Fang, “Stuttering detection using atrous convolutional neural networks”, in M. Quwaider (Ed.) 2022 13TH International Conference on Information and Communication Systems (ICICS) (proceedings of the 13th International Conference on Information and Communication System (ICICS), Irbid, JORDAN, Jun. 21-23, 2022), pp 252-256), and (b) Deep Learning Bidirectional Long-Short term memory techniques (see Sakshi Gupta, Ravi S. Shukla, Rajesh K. Shukla, and Rajesh Verma, “Deep Learning Bidirectional LSTM based Detection of Prolongation and Repetition in Stuttered Speech using Weighted MFCC”, International Journal of Advanced Computer Science and Applications 11(9) (2020) pp 345-356.

The app 114 then determines whether to keep the app 114 in the current app state, promote the app 114 to the next app state, or demote the app 114 to a previous app state, based upon the fluency metric. As in the methods of FIGS. 12A and 12B, the promotion manager 138 in FIG. 12C either performs the promotion decision directly, or presents the promotion decision as a recommendation to the user 10. In the illustrated example, the promotion manager 138 performs the promotion decision directly. The method begins in step 922.

In step 922, the app 114 is in a current state, labeled as state M, defined by a current GSE. In step 924, the app 114 receives an audio signal representation of the user speech. According to step 926, the app 114 determines a fluency metric based upon the audio signal representation of the user speech, where the fluency metric is in the form of fluency statistics 136 determined from the audio signal representation of the user speech. For this purpose, in a preferred implementation, the fluency monitor 118 determines the fluency statistics 136 based upon the audio signal representation of the user speech as the fluency metric. The method then transitions to step 810, where the app 114 sends the fluency metric to the promotion manager 138 for further processing.

Steps 808 through 822 of the promotion manager 138 are identical to steps 802 through 822 in the methods of FIGS. 12A and 12B. As a result, based on the fluency metric 136, the promotion manager 138 decides whether to remain in the same app state (and then transition back to step 922), demote the app 114 to the previous app state (and then transition back to step 922), or whether to transition to the next app state. If the current app state is the final app state, the method transitions to step 822 and concludes that the user is fluent; otherwise, the method transitions to the next app state (and then transitions back to step 922).

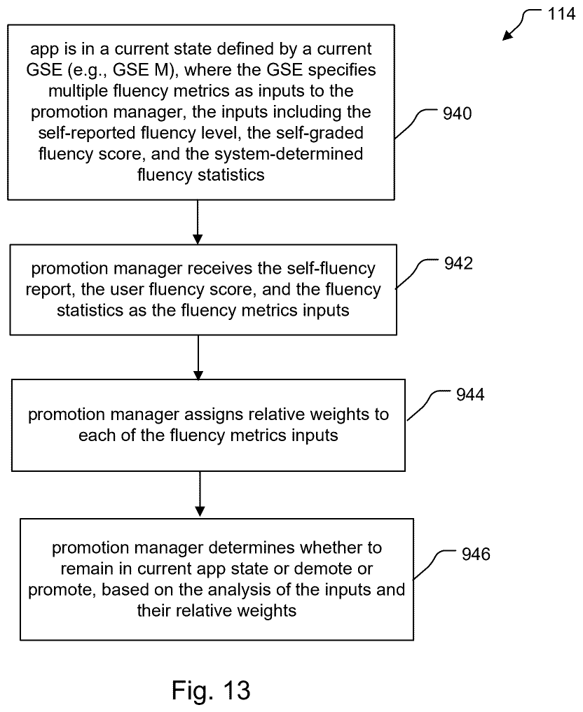

FIG. 13 shows still another method of the app 114. Specifically, the method shows more detail for operation of the promotion manager 138. Here, the app 114 uses the three fluency metrics obtained or otherwise determined in the methods of FIGS. 12A-12C as inputs, and then determines whether to remain in the same sate, promote to the next, or demote to the previous state based on a combination of the inputs. The method starts in step 940.

According to step 940, the app 114 is in a current state defined by a current GSE (e.g., GSE M), where the GSE specifies multiple fluency metrics as inputs to the promotion manager 138. The inputs include the fluency metric associated with the self-reported fluency level in FIG. 12A, the fluency metric associated with the self-graded fluency score of FIG. 12B, and the fluency metric associated with the system-determined fluency statistics of FIG. 12C. In step 942, the promotion manager 138 receives the self-fluency report, the user fluency score, and the fluency statistics as the fluency metrics inputs. Then, in step 944, the promotion manager 138 combines the inputs. In one implementation, the promotion manager 138 assigns relative weights to each of the fluency metric inputs. According to step 946, the promotion manager 138 determines whether to remain in the current app state or demote or promote, based on the analysis of the inputs and their relative weights and the upper and lower fluency threshold 224, 222 assigned to the current app state.

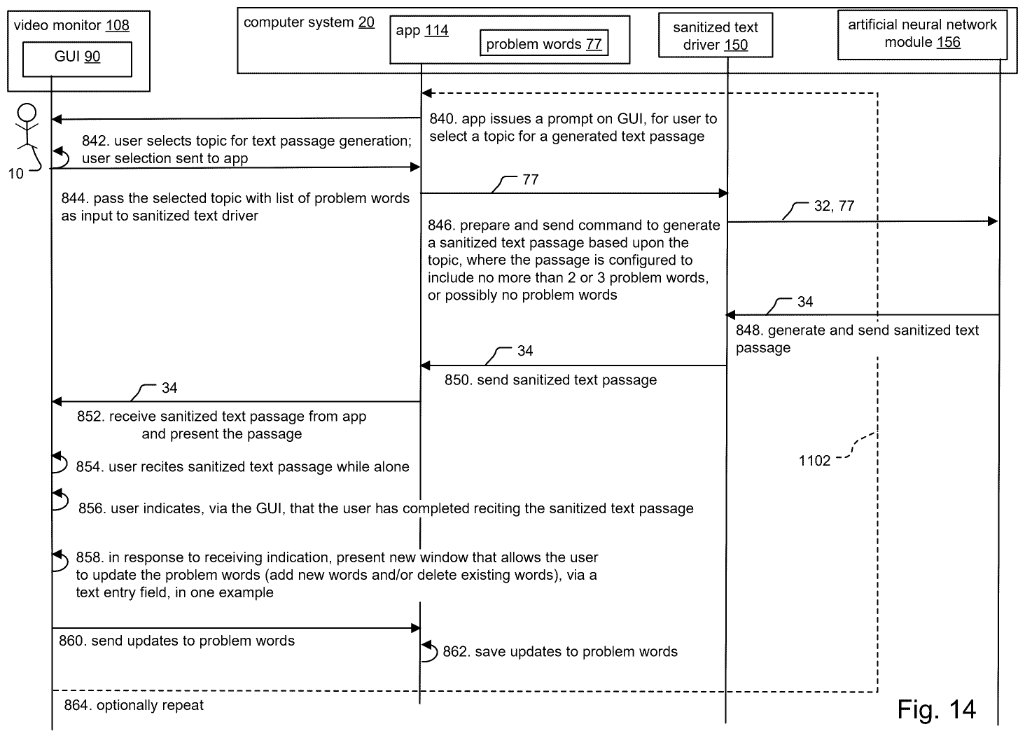

FIG. 14 illustrates a method of operation of the app 114 to implement GSE A-3 as defined in FIGS. 3 and 4. Specifically, the method describes how the app 114 presents a text passage for the user 10 to recite via the GUI 90, where the text passage has been generated without using any of the problem words 77 loaded into the memory 12 at system startup time. The processed text passage is also known as a sanitized text passage 34.

In a preferred implementation, the user 10 selects a topic of interest via the GUI 90. The app 114, in conjunction with the sanitized text driver 150 and the artificial neural network module 156, generates a sanitized text passage 34 based upon the selected topic. The method also enables the user to update the list of problem words 77 over time. In this way, any new sanitized text passages 34 generated by the system are processed using the updated problem words 77. The method begins at step 840.

In step 840, the app 114 issues a prompt on the GUI 90 for the user 10 to select a topic for a generated text passage. The user 10 selects a topic, and the GUI 90 sends the topic selection back to the app 114 in step 842. According to step 844, the app 114 passes the topic with the list of problem words 77 as input to the sanitized text driver 150. At step 846, the sanitized text driver 150 prepares and sends an instruction 32 that includes the topic and the problem words 77 to the artificial neural network module 156. The instruction 32 instructs the module 156 to generate a sanitized text passage 34 based upon the topic without any problem words 77 in the generated passage. In step 848, the artificial neural network module 156 generates and sends the sanitized text passage 34 back to the sanitized text driver 150 in response.

The artificial neural network module 156 includes one or more large language models that have been trained using up to hundreds of billions of words based on different topics. Sometimes, the sanitized text passages 34 generated by the module 156 includes none of the problem words 77. However, because the topics provided as input to the artificial neural network module 156 can vary in size and content, and because the size and number of language models in the module 156 can vary, the sanitized text passage 34 might include a few of the problem words 77 (typically, no more than two problem words).

Additionally and/or alternatively, the method in steps 840 through 848 might access the problem words 77 directly rather than passing the problem words 77 in commands (e.g., subroutine calls) between the app 114 and the modules 11, using system function calls, or the like. For this purpose, in one example, the problem words 77, the app 114, the sanitized text driver 150 and the artificial neural network module 156 could be loaded into a common block of shared memory 12 at system startup.

According to step 850, the sanitized text driver 150 sends the sanitized text passage 34 to the app 114, which then sends the sanitized text passage 34 to the GUI 90. The GUI 90 receives and presents the sanitized text passage 34 to the user 10 in step 852. In step 854, the user 10 recites the sanitized text passage 34 while alone. Once the user 10 has completed reciting the sanitized text passage 34, the user 10 indicates this via the GUI 90 (e.g., via selection of a “done”button) in step 856.

In step 858, the GUI 90 receives the indication, and in response, presents a new window in the GUI 90 that allows the user 10 to update the problem words (i.e., to add new words and/or to delete existing words). The new window might include a text entry field or other graphical element that allows the user 10 to update the problem words 77 in the GUI 90. In step 860, the GUI 90 sends the updates to the problem words 77 to the app 114, which saves the updates. This results in a replacement set of problem words 77 at the app 114 in step 862.

According to step 864, the GUI 90 can also prompt the user as to whether the user 10 wishes to select another topic for (sanitized) text generation. If the user declines, control passes back to the app 114, to an instruction in memory 12 prior to the execution of step 840. If the user accepts, control passes back to the beginning of step 840, thus repeating steps 840 to 862. This control path is indicated by a dashed arrow with reference 1102 in the figure.

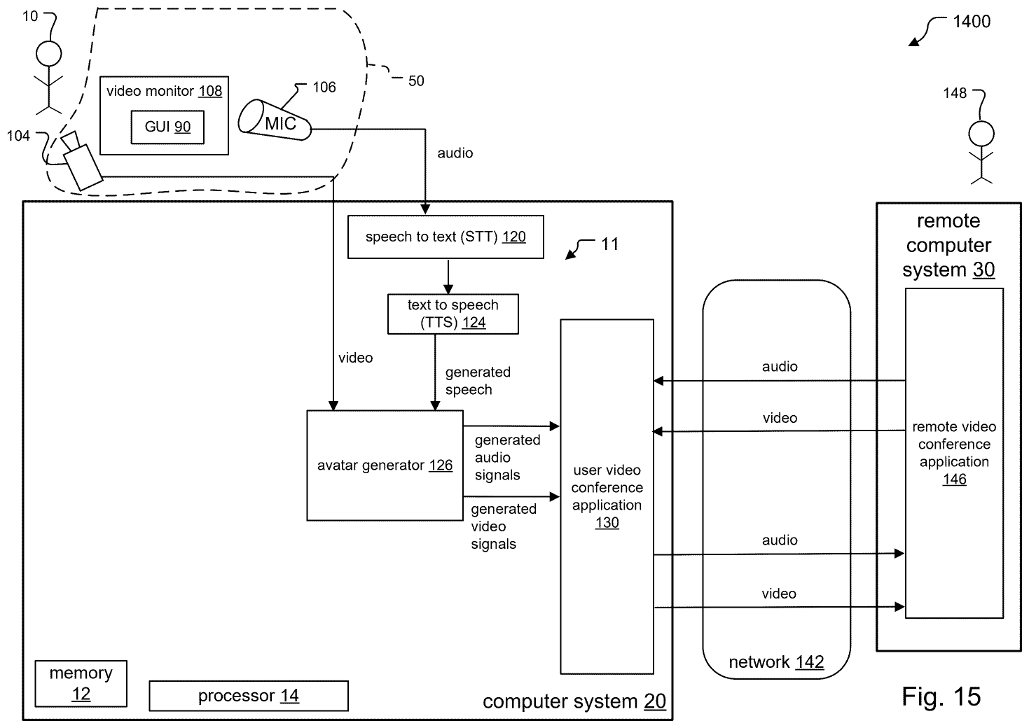

FIG. 15 shows yet another speech therapy system 1400, also known as a “Fluent Digital Twin”, which generates an audible and visible avatar of the user 10 which “stands in” for the user 10 during video conference calls. The system 1400 shares the hardware peripherals 50 and software modules 11 of GSE B-8 as defined in FIGS. 3 and 4, but it excludes the app 114 and the data repository 70. The hardware peripherals 50 and the hardware and software components within the computer system 20 represent a stand-alone application that creates a talking avatar image of the user 10, while avoiding transmitting audible speech of the user 10 to one or more RCPs 148.

In the illustrated example, the hardware peripherals 50 include the video camera 104, the MIC 106, the video monitor 108 and the speaker 110. Of the modules 11, only the STT module 120, the TTS module 124, the avatar generator 126 and the user video conference application 130 are either enabled or shown.

In the system 1400, image data of the user 10 captured by the video camera 104 is transmitted as input (labeled as ‘video’ in the figure) to the avatar generator 126. The microphone 104 converts the audible speech of the user 10 into an audio signal representation of speech. This signal is transmitted to the STT module 120, which transcribes the speech into a text stream. The text stream is then transmitted to the TTS module 124, which reconstructs the text stream into a reconstituted audio signal as output (labeled as ‘generated speech’ in the figure). The reconstituted audio signal can be generated to mimic the voice of the user 10 or optionally to mimic the voice of another individual. The reconstituted audio signal/‘generated speech’ is then passed as an additional input to the avatar generator 126.

The avatar generator 126 then generates, as output, video signals and audio signals of an avatar representing the user 10. These are indicated in the figure as ‘generated video signals’ and ‘generated audio signals’, respectively. Typically, the video signals would normally be constructed to resemble the user 10/would be based upon the image data of the user 10 passed as input to the avatar generator 126. Alternatively, the generated video signals of the avatar could be that of a “stock” figure that represents someone other than the user 10, or could even be a cartoon character. This is because some stuttering users 10 might feel more comfortable if the video signals of their avatars sent by the avatar generator 128 to the user video conference application 130, and ultimately presented to one or more RCPs 148 on the remote computer systems 30, did not resemble the users 10.

The generated audio signals and generated video signals produced by the avatar generator 126 are transmitted to the user video conference application 130, which converts the signals into the appropriate format for transmission over the network 142. The output video signals and the output reconstituted audio signals collectively form the fluent digital twin of the user 10.

Here, the user 10 is expected to be fluent because their actual speech would not be heard by a human other than themselves. Also, if the user 10 did exhibit a few residual disfluent utterances during speech, the STT module 120 might remove the disfluent utterances, especially if the STT module 120 were based on one or more Large Language Models. This system 1400 has value to users who stutterer because it enables the users 10 to deliver fluent presentations in video conference calls along with a reasonable representation of their physical image during their speech. This system could be made available as an add-on to video conference applications themselves, such as Google Meet and Zoom. As is customary in video conference calls, the video and audio signals from RCPs 148 would also be transmitted by the remote video conference applications 146 through the network 142 to the user video conference application 130 and then routed to the user's speaker 110 and video monitor 108. Effectively, from the perspective of the user 10, such video conferences would be “animated avatar out”, and “real audio +video”in.

In this way, the speech therapy system 1400 is a fluency system that includes various components and provides a fluent digital twin of the user 10 for presentation to other users 10 or RCPs 148. The fluency system includes a computer system 20 including a processor 14 and a memory 12; a user video conference application 130 loaded into the memory 12 and executed by the processor 14; a speech to text module, also known as a STT module 120, loaded into the memory 12 and executed by the processor 14; a text to speech module, also known as a TTS module 124, loaded into the memory 12 and executed by the processor 14; and an avatar generator module 126 loaded into the memory 12 and executed by the processor 14.

More detail for the fluency system is as follows. The user video conference application 130 is configured to establish a video conference session between a user 10 of the computer system 20 and at least one RCP 148 at a remote computer system 30. The STT module 120 is configured to receive, as input, an audio signal representation of user speech from a microphone 106 of the computer system 20, and to produce, as output, a text stream of the user speech. The TTS module 124 is configured to receive, as input, the text stream of the user speech from the STT module 120, and to produce, as output, reconstituted audio signals of the user speech.

The avatar generator module 126 is configured to: 1) receive, as input, image data of the user captured by a video camera 104 of the computer system 20, and the reconstituted audio signals of the user speech; and 2) to produce, as output, video signals of an avatar representing the user and the reconstituted audio signals, where the video signals of the avatar include animated lip and facial expressions of the user 10 based upon the image data and/or the reconstituted audio signals. The output video signals of the avatar and the output reconstituted audio signals are sent to the user video conference application 130 and collectively form a fluent digital twin of the user. The user video conference application 130 then sends the fluent digital twin of the user over the video conference session to the at least one RCP 148.

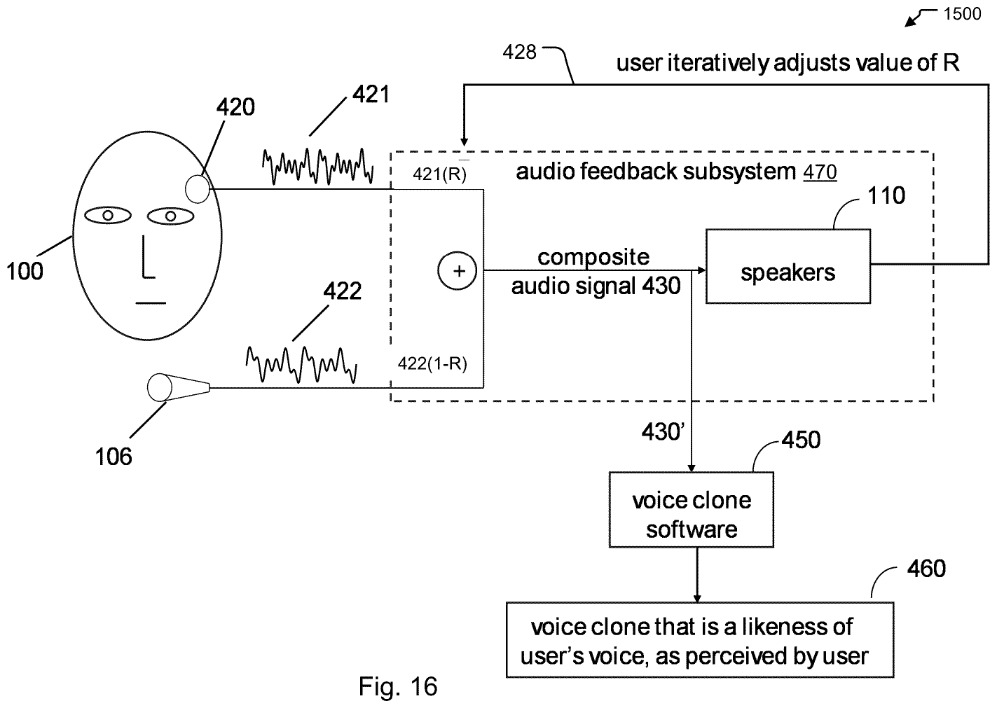

FIG. 16 shows components of another speech therapy system 1500 that creates an audio signal representation of user speech that sounds like the user 10, as perceived by the user 10. The system includes an “air” microphone 106, a bone conduction microphone 420, speakers 110, and voice clone software 450. The system 1500 also includes an audio feedback subsystem 470 that enables the user 10 to iteratively tailor output sound amplitude of the microphones 106, 420. The speakers 110 are included as a component of the audio feedback subsystem 470.

The system 1500 generally operates as follows. The microphone 106 produces an audio signal representation 422 of the user speech, while the bone conduction microphone 420 represents the speech as vibrations 421. Via the audio feedback subsystem 470, the user 10 can apply weighting factors to the audio signals 421 and the vibrations 422. In the illustrated example, the user chooses a value of R in the range 0<R<1, and a weighting factor of R is applied to the vibrations 421 (i.e., the vibrations 421 are multiplied by R) and a weighting factor of (1−R) is applied to the audio signals 422. As a result, the total audio amplitude is fixed. After the weighting factors are applied, the signals 421, 422 are combined into a composite audio signal 430 which is presented to the speakers 110. The user 10 can then repetitively listen to the composite audio signal 430 and adjust the weighting factors in the subsystem 470 until the user identifies weighting factors that yield an optimum composite audio signal 430′ that sounds most like the user, as perceived by the user.

This repeated listening and adjustment of the audio by the user 10, to obtain the optimum composite signal 430′ as perceived by the user 10, is indicated by the feedback arrow with reference 428. During these iterations, the user 10 might also adjust the relative weights applied to each of the signals 421, 422 to obtain the optimum composite signal 430′.

The audio feedback subsystem 470 then transmits the optimum composite audio signal 430′ to the voice clone software 450 for processing. The voice clone software 450 creates an audio signal “voice clone” that is a likeness of the user's voice, where the likeness is more akin to what the user hears when speaking.

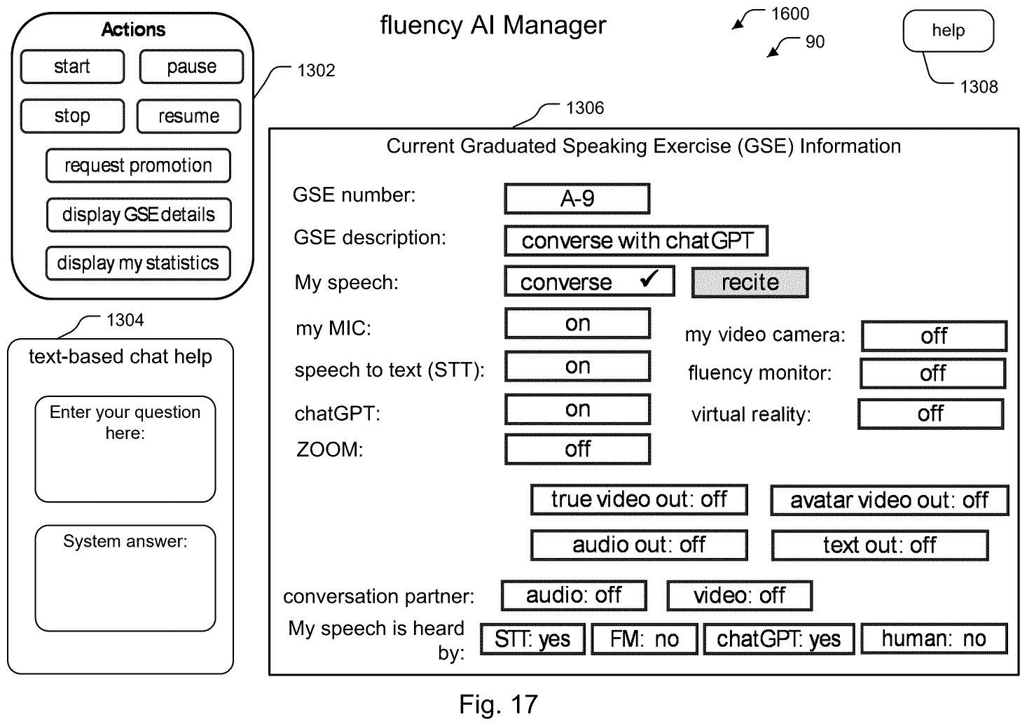

FIG. 17 shows an exemplary manager screen 1600 of the app 114, displayed within the GUI 90. The manager screen 1600 includes a main window 1306, an actions window 1302, a help window 1304 and a help button 1308. The manager screen 1600 displays information for exemplary GSE A-9.

In the illustrated example, the main window 1306 is entitled “Current Graduation Speaking Exercise Information” and enables the user to view, within the app 114 and GUI 90, the specifications for the current GSE. The specifications are defined by the associated GSE module 40 of the current GSE and include the hardware peripherals 50 and software modules 11 which are enabled in the current GSE. The actions window 1302 allows the user to request promotion to a new app state, to start, stop, or pause a current GSE, and to display statistics for the current GSE, in examples. The help window 1304 provides text-based user help in the form of typed questions, and generated responses. The help button 1308 might open a user manual or other documentation in response to its selection.

In one implementation, the speech therapy system 100 (here, via the manager screen 1600) does not provide any capability for the user 10 to configure the GSEs. Rather, the configuration of each GSE is completely specified by its associated GSE module 40, the latter of which is static and not configurable by the user 10. In the illustrated example, the boxes e.g., “speech-to-text (STT): ON” and “chatGPT ON” are displaying the values of parameters in the GSE module 40 for this GSE that specify which of the modules 11 are activated. These boxes do not allow the user 10 to modify those values.

In another implementation, one or more GSEs are configurable by the user 10. While stuttering research has shown that private speech and choral reading are known to strongly promote fluency, less is known about the efficacy of software modules for accomplishing same. For this reason, in this embodiment, users 10 can adjust some characteristics of a given GSE that affect the level of fluency anxiety created by the GSE. This ‘adaptive’ feature will be useful if users experience a less than acceptable level of fluency in a GSE; rather than revert to a previous GSE, the users can instead adjust a GSE's characteristics to reduce its propensity to engender fluency anxiety.

For example, table 302 in FIG. 3 indicates that users recite unsanitized text passages in GSE A-7. With an adaptive interface, the user 10 might change these GSEs to instead allow the user 10 to recite sanitized text passages. Similarly, many of the GSEs in table 302 call for recitations of text in the absence of the assistance of the choral reader 190, but a user could elect instead to request the choral reader 190.

In yet another example, via the adaptive interface, the user 10 might disable the fluency monitor 118 in GSEs that normally enable this module. This is because some users may find that having the fluency of their speech rated, even if by only a software module, provokes excessive anxiety about speaking fluently. In still another example, for many of the GSEs starting with A-6 in FIG. 3, the STT module 120 is shown as being optional. Via the adaptive interface, users 10 could elect to disable the STT module 120 or to enable the STT module 120 and thereby to display their transcribed speech on their video monitors 108. In still other examples, via the adaptive interface, users 10 may elect to turn off their outgoing video signal to RCPs 148 in video conference calls, or they may elect to turn off the incoming video signals transmitted from RCPs 148 to the users 10.

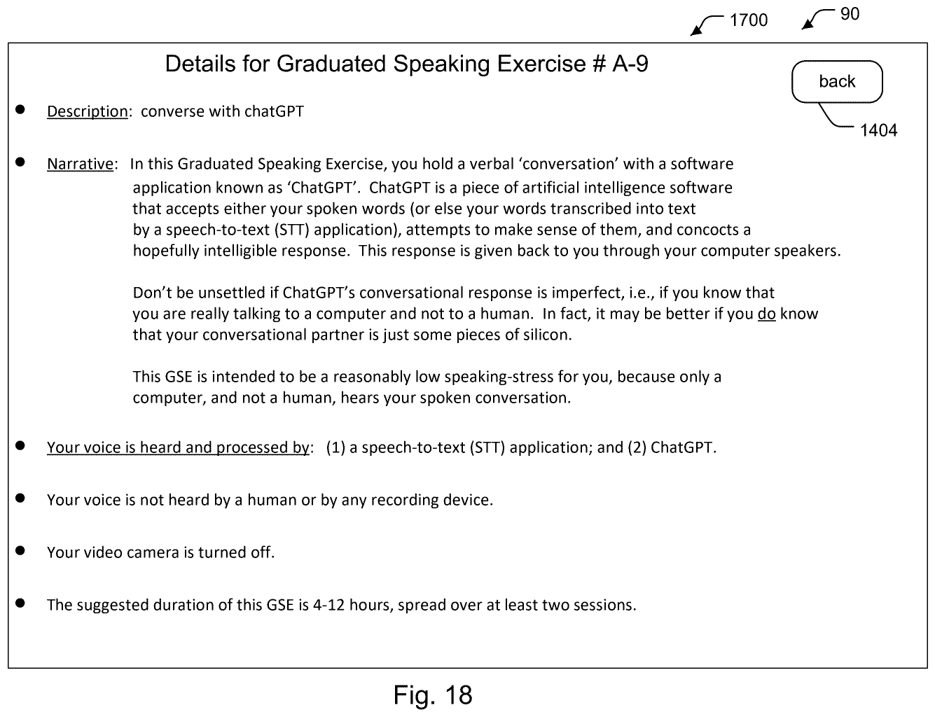

FIG. 18 shows a GSE Details screen 1700 of the app 114 within the GUI 90. As its name suggests, the GSE Details screen 1700 shows details associated with the GSE of the current app state, including a name/description, a narrative of the actions the user 10 is expected to perform, and what other components and entities the user 10 is expected to interact with during the app state.

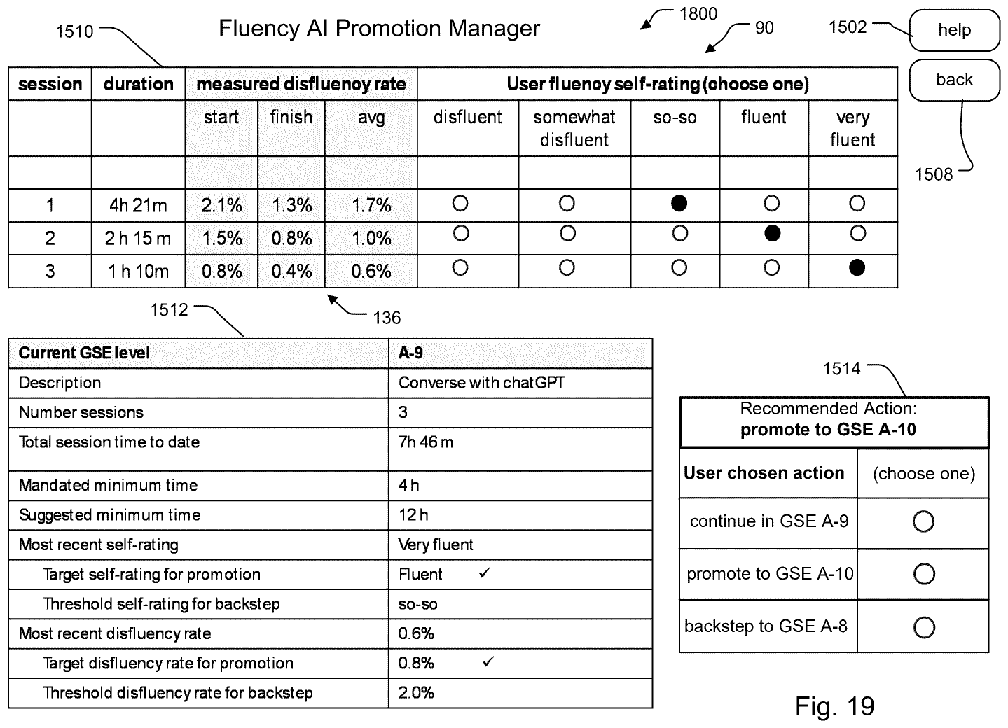

FIG. 19 shows a promotion manager screen 1800 of the app 114 within the GUI 90. The screen 1800 includes a main table 1510 with headings/column numbers including a session, duration, measured disfluency rate, and a user fluency self-rating. The screen 1800 also includes a GSE statistics table 1512 and a promotion selection table 1514. The GSE statistics table 1512 presents information for the current GSE.

The promotion manager screen 1800 recommends a promotion decision that is derived from (a) the fluency statistics 136 of the current GSE; (b) the minimum conversation time 226 as specified in the GSE and (c) the upper and lower fluency thresholds 224, 222 as specified in the GSE. The screen 1800 also enables the user to choose whether to promote to the next GSE, to remain in the current GSE, or to demote to a previous GSE, based on the recommended promotion decision and/or the user's specified considerations.

The main table 1510 lists some fluency statistics 136 for all of the user's conversational sessions in this GSE. The module statistics table 1512 compares the fluency statistics 136 with the upper and lower fluency thresholds 224, 222 and the total time the user has spent in this GSE compared to the minimum conversation time 226 defined for this GSE. The “check marks” in table 1512 indicate that the upper fluency threshold 224 was exceeded in the most recent session, and the total time the user spent in this GSE exceeds the minimum conversation time 226 defined for this GSE. On this basis, the promotion manager 138 concludes that the user 10 qualifies for promotion to the next GSE, and this conclusion is displayed as the “recommended action” in the promotion selection table 1514. However, at least in this implementation, the user 10 is allowed to make the final decision about whether to be promoted to the next GSE/next app state, be demoted to the previous GSE/previous app state, or remain in the current GSE/current app state. For this purpose, the user 10 typically considers the promotion manager's recommendation and the user's own inclinations.

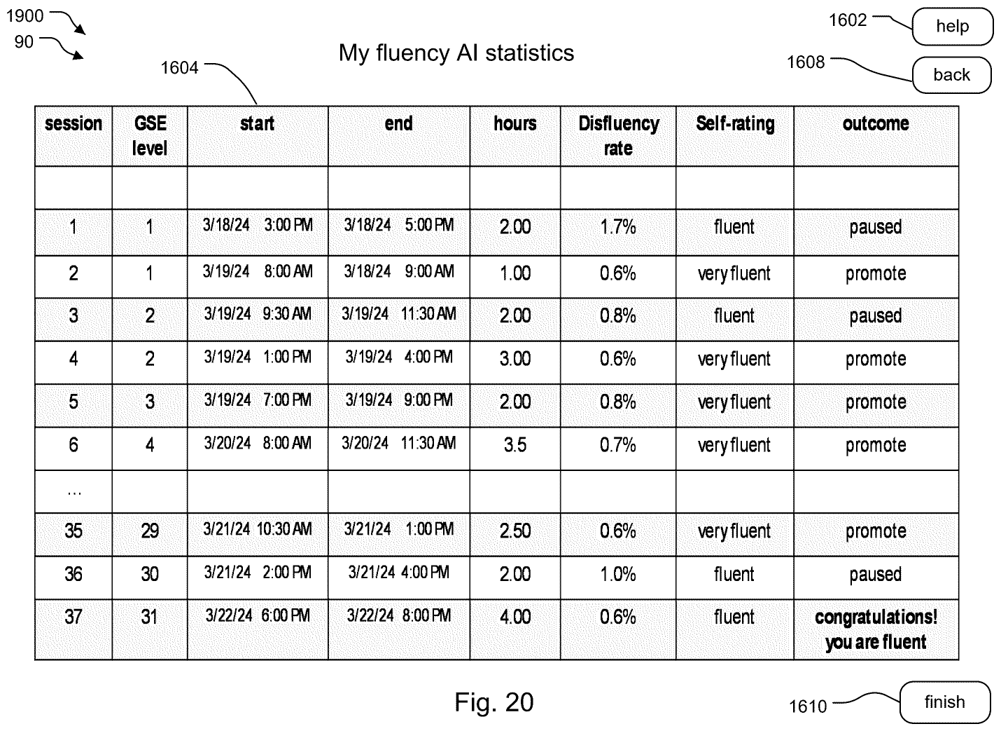

FIG. 20 shows a statistics screen 1900 of the app 114 within the GUI 90. The screen 1900 includes a statistics table 1604, a help button 1602, a back button 1608 and a finish/done button 1610. The screen presents these statistics to the user 10 to give some recognition to the user 10 for the many hours that he or she has invested in the therapy, and to provide the user 10 with a succinct, high-level overview of the evolution of his or her fluency over the course of the therapy, in examples. Depending on the reported fluency values, the displayed fluency data may encourage the user to continue some possibly tedious GSEs, or alternately to discontinue the therapy, if for example the fluency levels are marginal and are not improving over time.

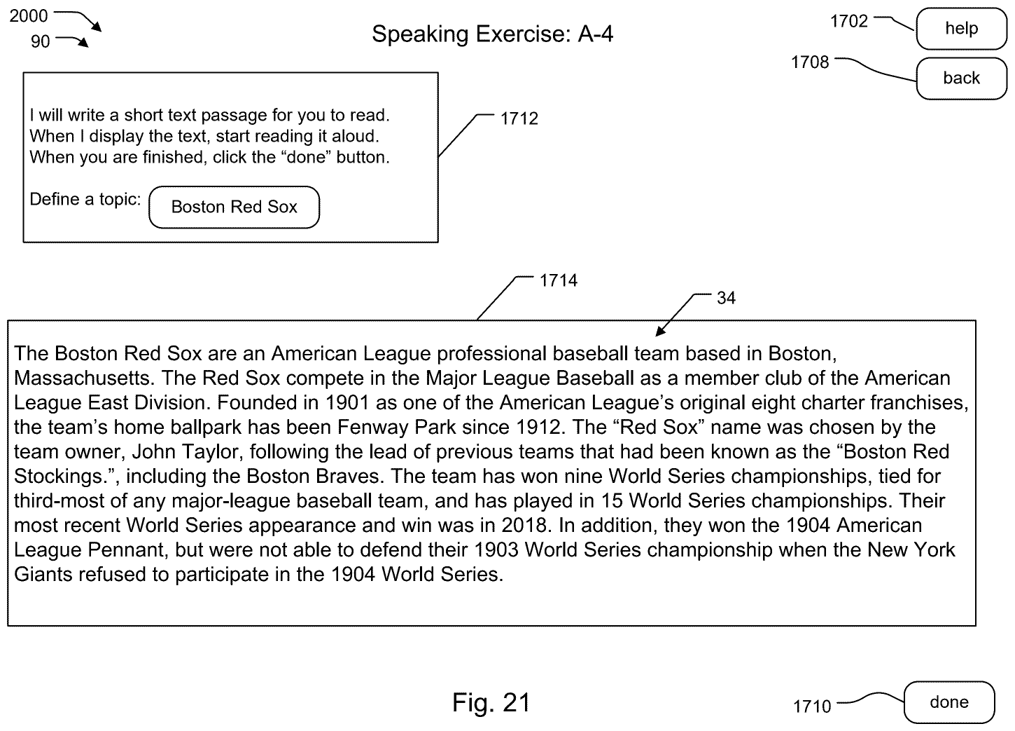

FIG. 21 shows a GSE screen 2000 of the app 114 within the GUI 90. The GSE screen 2000 has a title of “Speaking Exercise: A-4” for the current GSE, GSE A-4. The GSE screen 2000 includes a GSE text display window 1714 within which a GSE text passage is displayed, a GSE selection window 1712, a help button 1702, a back button 1708 and a finish/done button 1710. The GSE selection window 1712 allows the user to enter a topic, and the GSE screen 2000 will generate a text passage 34 for the user to recite in the GSE text display window 1714 based upon the topic. This screen would have a similar appearance irrespective of whether sanitized text passages or unsanitized text passages are generated for the user to recite.

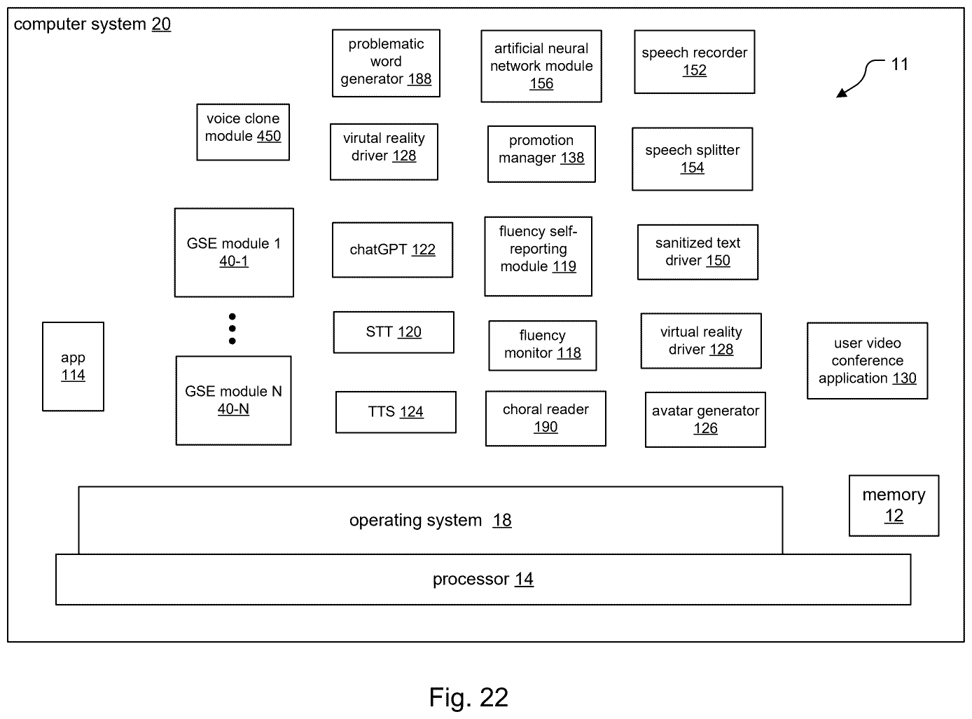

FIG. 22 shows more detail for the computer system 20 in the various speech therapy systems described herein above. The computer system 20 includes an operating system 18, the processor 14 and the memory 12, the app 114, the user video conference application 130 and the modules 11. The computer system 20 can be a desktop computer system, or a user device such as a smart phone, laptop, computer tablet or phablet, in examples.

The operating system 18 enables application code of the modules 11 and other applications to be loaded and executed at run-time by the processor 14. Specifically, the operating system 18 can load the application code within the memory 12 for execution by the processor 14, and schedule the execution of the application code by the processor 14. The processor 14 might be a microcontroller or a microprocessor, in examples.

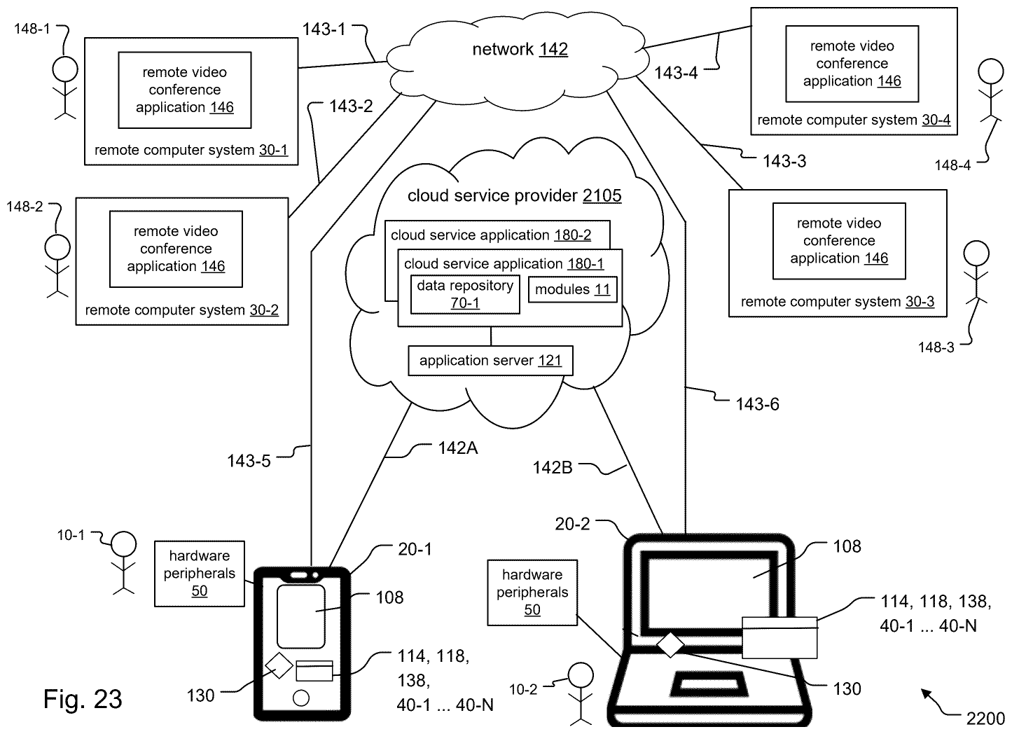

FIG. 23 shows yet another speech therapy system 2200, according to another embodiment. Here, some components of the system 2200 are provided as a software as a service (SaaS) or infrastructure as a service (IaaS).

The system 2200 includes a network 142, a cloud service provider 2105 separate from the network 142, one or more users 10-1 and 10-2 who access the system 2200 via their respective computer systems 20-1 and 20-2, and multiple RCPs 148 that access the system 2200 via their remote computer systems 30. RCPs 148-1 through 148-4 are shown at their respective remote computer systems 30-1 through 30-4. The computer system 20-1 is a smart phone, while the computer system 20-2 is a laptop.

The computer systems 20 each include an app 114, a user video conference application 130, a fluency monitor 118, a promotion manager 138, GSE modules 40-1. 40-N. Hardware peripherals 50 connect to each of the computer systems 20.

The cloud service provider 2105 includes an application server 121 and provides a separate instance of a cloud service application 180-1 and 180-2 to each of the users 10-1 and 10-2, respectively. Each cloud service application 180 includes zero or more modules 11 and/or a data repository 70.

The remote computer systems 30 each include a remote video conference application 146. The computer systems 20 and the remote computer systems 30 connect to and communicate with one another over the network 142. The network 142 can be a private or public network (e.g., the Internet).

The system 2200 is arranged as follows. The remote computer systems 30-1 through 30-4 each connect to the network 142 via communications links 143-1 through 143-4, respectively. Computer systems 20-1 and 20-2 connect to the network 142 via communications links 143-5 and 143-6, respectively. Computer systems 20-1 and 20-2 also connect separately to the cloud service provider 2105 via communications links 142A and 142B, respectively.

The essential point of this system 2200 is that zero or more of modules 11, the app 114, the fluency monitor 118, the promotion manager 138, and the data repository 70 can reside ‘in the cloud’ rather than on the users'computing devices 20 (laptops, smart phones, etc.). The decision to use cloud-based services as opposed to services installed directly onto the computer systems 20 will be informed by engineering considerations such as the required computer memory and computational power of individual modules, the latency of transmitting signals to and from the cloud-based service 2105, and the greater ease of implementing upgrades in cloud-based services, in examples. Additionally, if engineering considerations are met, some modules might be in the form of cloud-based services to minimize cost.

In the illustrated example, the cloud service applications 180-1 and 180-2 each include one or more modules 11 and a separate instance of the data repository 70. Here, the cloud service application 180-1 is shown in detail and includes one or more modules 11 and an instance of the data repository 70-1. The app 114, the fluency monitor 118, the promotion manager 138, the user video conference application 130 and the GSE modules 40, however, are components within the computer systems 20-1 and 20-2.

However, in another implementation, the modules 11, the app 114, the fluency monitor 118, the promotion manager 138, the data repository 70, and/or the GSE modules 40 might be included in or otherwise provided by the cloud service provider 2105. In this other implementation, however, the users'computer systems 20 must include the user video conference application 130.

In the illustrated example, the app 114 of each computer system 20-1, 20-2 includes the GSE modules 40, the promotion manager 138 and the fluency monitor 118 as in the systems 100, 500, 700, 800, 900 and 1000 described hereinabove. The hardware peripherals 50 can also include the full list of peripherals shown in the system 100 of FIGS. 1A and 1B, but are not shown due to limited page size. Typically, most if not all of the remaining modules 11 (other than the user video conference application 130) are included in a separate instance of the cloud service application 180 for each user 10/computer system 20.

The cloud service applications 180 run on one or more computing nodes such as servers (not shown) that are included within a private or public cloud service provider 2105 such as IBM Cloud, Amazon AWS, Microsoft Azure and Goggle Cloud, in examples. The cloud service applications 180 are isolated from each other to provide data and access security.

In the illustrated example, two users 10-1 and 10-2, four RCPs 148-1. 148-4 and two instances of the cloud service application 180-1 and 180-2 are shown. Via the app 114, the users 10-1, 10-2 connect to the application server 121 of cloud service provider 2105 via secure communications links 142A and 142B, respectively. The application server 121 determines whether the users are authorized users of the cloud service provider 2105 and creates the separate instances of the cloud service application 180-1, 180-2.

These computer systems 20-1, 20-2 may have fewer computing resources than desktop computer systems. However, because the majority of the modules 11 are included in the cloud service application 180 and use the memory and computing resources of the cloud service provider 2105, the user 10 can still operate the system 2200 in many of not all of its app states/GSEs. Here, the user 10 is typically limited only by the number and type of hardware peripherals 50 that their specific computer system 20-1, 20-2 supports.

While this invention has been particularly shown and described with references to preferred embodiments thereof, it will be understood by those skilled in the art that various changes in form and details may be made therein without departing from the scope of the invention encompassed by the appended claims. In particular, although the sequential ordering of the Campaigns A, B, C, and D to effect a series of speech environments of increasing conversational realism and increasing propensity to engender fluency anxiety is well established by stuttering research, the specific ordering of GSEs within individual Campaigns is less well defined by research. In addition, clinical testing of the proposed speech therapy system may determine that some of the GSEs may provide only moderate improvements to a user's fluency in more realistic conversational environments. As a result, the number of GSEs in the speech therapy system, and their detailed sequential ordering, may differ from the disclosed embodiments without departing from the scope of the invention encompassed by the appended claims.

What is claimed is:

1. A speech therapy system, the system comprising:
graduated speaking exercise modules, also known as GSE modules, each configured to provide a graduated speaking exercise, also known as a GSE, for a stuttering user, wherein the GSE modules are arranged sequentially to provide GSEs of increasing conversational realism from each GSE to a next GSE in the sequence; and
a computer system including a processor and a memory, wherein the computer system is configured to:
load a fluency management application, also known as an app, into the memory for execution by the processor; and
load the GSE modules into the memory for execution by the app, wherein upon execution of the GSE modules, the app creates a GSE for each GSE module that defines a different state of the app;
wherein when the app is in a current app state defined by a current GSE, the app is configured to:
either present at least one text passage to the user and prompt the user to recite the text passage aloud, wherein the recitation of the text passage forms user speech, or enable the user to speak aloud extemporaneously with another person or with a software entity, wherein the user extemporaneous speech forms the user speech, and wherein the user extemporaneous speech or a transcription thereof is transmitted by the app to the other person or to the software entity; and
upon the app determining that the user speech at least meets a fluency threshold of the current GSE, the app recommends that the user transition to a next app state associated with a next GSE of the current GSE; and
wherein when the app is in a final app state defined by a final GSE, upon the app determining that the user speech during the final GSE at least meets a fluency threshold of the final GSE, the app concludes that the user is fluent and notifies the user in response.

2. The speech therapy system of claim 1, wherein the app determines that the user speech at least meets the fluency threshold of the current GSE by obtaining a fluency metric based upon the user speech, and wherein the app obtains the fluency metric by either:
receiving a fluency self-rating provided by the user, wherein the fluency self-rating is the fluency metric;
presenting a fluency challenge test to the user, requesting the user to recite words in the challenge test, and receiving a fluency score from the user based upon the user speech during the challenge test, wherein the fluency score is the fluency metric; or passing the user speech as input to a fluency monitor module that is loaded into the memory and executed by the processor, wherein the app sends an audio signal representation of the user speech as input to the fluency monitor module, and wherein the fluency monitor module calculates the fluency metric as output.

3. The speech therapy system of claim 1, further comprising:
an artificial neural network module that is loaded into the memory and executed by the processor;
wherein during an app state associated with at least one GSE, the app passes a list of problem words as input to the artificial neural network module, and directs the artificial neural network module to create a sanitized text passage that excludes one or more of the problem words; and
wherein the artificial neural network module presents the sanitized text passage to a monitor of the computer system for the user to recite aloud, and wherein the recitation of the sanitized text passage by the user forms the user speech.

4. The speech therapy system of claim 3, further comprising:
a sanitized text driver module that is loaded into the memory and executed by the processor, wherein the sanitized text driver module accesses the list of problem words and is in communication with the artificial neural network module;
wherein the sanitized text driver module directs the artificial neural network module to generate the sanitized text passage that excludes the one or more of the problem words.

5. The speech therapy system of claim 3, wherein the artificial neutral network module creates the sanitized text passage by:
accessing a stored text passage from the memory;
rewriting the stored text passage into a rewritten text passage that removes one or more of the problem words and is designed to convey a similar meaning as the stored text passage; and
providing the rewritten text passage as the sanitized text passage.

6. The speech therapy system of claim 1, further comprising:
an artificial conversation module that is loaded into the memory and executed by the processor, wherein the artificial conversation module:
receives as input either an audio signal representation of the user speech or a text-based representation of the user speech;
generates conversational responses to the input; and
presents the conversational responses to a video monitor or a speaker of the computer system.

7. The speech therapy system of claim 1, further comprising:
a speech-to-text module, also known as an STT module, that is loaded into the memory and executed by the processor, wherein the STT module receives an audio signal representation of the user speech from the app as input and outputs a text-based representation of the user speech;
wherein for at least one GSE, the app sends the text-based representation of the user speech to a human conversational partner on a remote computer system.

8. The speech therapy system of claim 7, wherein the human conversational partner provides audio responses to the text-based representation of the user speech, and wherein the remote computer system sends audio signal representations of the audio responses to the app of the user computer system, and wherein the app presents the audio signal representations to speakers or a headset connected to the user computer system.

9. The speech therapy system of claim 7, wherein the remote computer system transmits text-based representations of the human conversational partner's responses to the app, and wherein the app presents the text-based responses to a video monitor of the user computer system.

10. The speech therapy system of claim 1, wherein the app creates an audio recording of the user speech, and wherein the app sends the recording to a human conversational partner on a remote computer system upon receiving an indication of approval from the user.

11. The speech therapy system of claim 1, wherein the app sends audio signals of the user speech to a remote human conversational partner on a remote computer system, and wherein the remote human conversational partner responds with audible speech, and wherein the remote computer system sends audio signal representations of the audible speech to the app of the computer system.

12. The speech therapy system of claim 1, wherein the computer system transmits the user speech to one or more remote human conversational partners on remote computer systems, and wherein the computer system transmits image data of the user captured by a video camera to the one or more remote human conversational partners at the remote computer systems, and wherein the remote computer systems present the image data to monitors of the remote computer systems.

13. The speech therapy system of claim 1, wherein the computer system transmits the user speech to one or more remote human conversational partners on remote computer systems, and wherein video cameras connected to the remote computer systems capture image data of the remote human conversational partners, and wherein the remote computer systems transmit the image data of the remote human conversational partners to the user computer system, and wherein the app presents the image data of the remote human conversational partners to a video monitor of the computer system.

14. The speech therapy system of claim 1, further comprising:
a video monitor connected to the computer system; and
an avatar generator module loaded into the memory and executed by the processor, wherein for at least one GSE, the avatar generator module is configured by the app to render an avatar representing the user and to present the avatar to the video monitor, and to optionally send the avatar to a human conversational partner on a remote computer system.

15. The speech therapy system of claim 1, wherein each of the GSEs includes a lower fluency threshold and an upper threshold, and wherein when the app determines that a fluency metric obtained from the user speech is greater than the lower fluency threshold of the GSE that defines the current app state but less than the upper fluency threshold of the GSE that defines the current app state, the app is configured to remain in the current app state.

16. The speech therapy system of claim 15, wherein when the app determines that the fluency metric is less than the lower fluency threshold of the GSE that defines the current app state, the app is configured to transition to a previous app state associated with a previous GSE of the GSE that defines the current app state.

17. The speech therapy system of claim 1, wherein each GSE includes a minimum conversation time for the user speech, and wherein when the app determines that the user speech has occurred over a time period that is less than the minimum conversation time of the GSE that defines the current app state, the app is configured to remain in the current app state.

18. The speech therapy system of claim 1, wherein each GSE includes:
an upper fluency threshold; and
a minimum conversation time for the user speech;
wherein when the app determines that 1) the user speech has occurred over a time period that is greater than the minimum conversation time of the GSE that defines the current app state, and 2) a fluency metric obtained from the user speech at least meets the upper fluency threshold of the GSE that defines the current app state, the app is configured to transition to the next app state associated with the next GSE of the GSE that defines the current app state.

19. The speech therapy system of claim 1, further comprising a virtual reality device, also known as a VR device, worn by the user, wherein for at least one GSE, the app is configured to present image data of a virtual audience to a display of the VR device, while the user is reciting the user speech, and wherein members of the virtual audience do not respond verbally to the user speech.

20. The speech therapy system of claim 1, further comprising a virtual reality device, also known as a VR device, worn by the user, wherein for at least one GSE, the app is configured to present image data of a virtual audience to a display of the VR device, and wherein one or more members of the virtual audience respond verbally to the user speech.

21. The speech therapy system of claim 1, wherein for at least one GSE, the app receives an
audio signal representation of the user speech, and divides the audio signal representation into a plurality of audio snippets that each include one or more words of the audio signal representation of the user speech;
wherein the app transmits at least a subset of the audio snippets to a remote human conversational partner on a remote computer system; and
wherein the remote human conversational partner provides audio responses to the audio snippets, and wherein the remote computer system sends audio signal representations of the responses to the app of the computer system, and wherein the app presents the audio signal representation of the responses to speakers or to a headset of the computer system.

22. The speech therapy system of claim 1, further comprising:
a choral reader module that is loaded into the memory and executed by the processor, wherein the choral reader module is configured to receive a text passage as input from the app, and to generate an audio signal representation of the text passage, also known as a choral reader audio signal, as output;
wherein for at least one GSE, the choral reader audio signal is presented audibly to the user, and wherein the user recites the text passage aloud in unison with the presented choral reader audio signal.

23. The speech therapy system of claim 1, wherein one or more GSEs include characteristics which are designed to increase or decrease fluency anxiety in the users, and wherein the characteristics are configurable by the user.

24. A method for a speech therapy system, the method comprising:
graduated speaking exercise modules, also known as GSE modules, each providing a graduated speaking exercise, also known as a GSE, for a stuttering user, wherein the GSE modules are arranged sequentially to provide GSEs of increasing conversational realism from each GSE to a next GSE in the sequence;
loading a fluency management application, also known as an app, into a memory of a computer system, and executing the app via a processor of the computer system;
loading the GSE modules into the memory, and executing the GSE modules, wherein upon execution of the GSE modules, the app creating a GSE for each GSE module that defines a different state of the app;
wherein when the app is in a current app state defined by a current GSE, the app either:
presenting at least one text passage to the user and prompting the user to recite the text passage aloud, wherein the recitation of the text passage forms user speech; or
enabling the user to speak aloud extemporaneously with another person or with a software entity, wherein the user extemporaneous speech forms the user speech, and wherein the user extemporaneous speech or a transcription thereof is transmitted by the app to the other person or to the software entity; and
upon the app determining that the user speech at least meets a fluency threshold of the current GSE, the app recommending that the user transition to a next app state associated with a next GSE of the current GSE; and
wherein when the app is in a final app state defined by a final GSE, upon the app determining that the user speech during the final GSE at least meets a fluency threshold of the final GSE, the app concluding that the user is fluent and notifying the user in response.

25. A fluency system, the fluency system comprising:
a computer system including a processor and a memory;
a video conference application loaded into the memory and executed by the processor, wherein the video conference application is configured to establish a video conference session between a user of the computer system and at least one remote human conversational partner at a remote computer system;
a speech to text module, also known as a STT module, loaded into the memory and executed by the processor, that is configured to receive, as input, an audio signal representation of user speech from a microphone of the computer system, and to produce, as output, a text stream of the user speech;
a text to speech module, also known as a TTS module, loaded into the memory and executed by the processor, that is configured to receive, as input, the text stream of the user speech from the STT module, and to produce, as output, reconstituted audio signals of the user speech; and
an avatar generator module loaded into the memory and executed by the processor, wherein the avatar generator module is configured to:
receive, as input, image data of the user captured by a video camera of the computer system, and the reconstituted audio signals of the user speech; and
produce, as output, video signals of an avatar representing the user and the reconstituted audio signals, wherein the video signals of the avatar include animated lip and facial expressions of the user based upon the image data and/or the reconstituted audio signals;
wherein the output video signals of the avatar and the output reconstituted audio signals collectively form a fluent digital twin of the user, and wherein the video conference application sends the fluent digital twin of the user over the video conference session to the at least one remote human conversational partner.
